(19) United States
(12) Patent Application Publication
(10) Pub. No.: US 2024/0419727 A1
(43) Pub. Date: Dec. 19, 2024

(54) NETWORK INFRASTRUCTURE FOR USER-SPECIFIC GENERATIVE INTELLIGENCE

(71) Applicant: SoftEye, Inc., San Diego, CA (US)

(72) Inventors: Edwin Chongwoo Park, San Diego, CA (US); Te-Won Lee, San Diego, CA (US); DoYoung Lee, Seoul (KR); Aravind Natarajan, Dublin, CA (US)

(73) Assignee: SoftEye, Inc., San Diego, CA (US)

(21) Appl. No.: 18/745,353

(22) Filed: Jun. 17, 2024

Related U.S. Application Data
(60) Provisional application No. 63/565,974, filed on Mar. 15, 2024.
(60) Provisional application No. 63/508,650, filed on Jun. 16, 2023.

(51) Int. Cl. G06F 16/587; G06F 16/583; G06F 40/284; G06V 10/22; G06V 10/25

(52) U.S. Cl. CPC G06F 16/587; G06F 16/583; G06F 40/284; G06V 10/235; G06V 10/25

(57) ABSTRACT

Network infrastructure for user-specific generative intelligence. Providing user-specific context to a generically trained LLM introduces a variety of complications (privacy, resource utilization, training costs, etc.). Various aspects of the present disclosure provide novel user-specific data structures, privacy and access control, layers of data, and session management, within a network infrastructure for generative intelligence. For example, user-specific embedding vectors may be used to provide user context to a generically trained foundation model. In some variants, edge devices capture multiple modalities of user context (images, audio; not just text). Privacy and access control mechanisms also allow a user to control information that is captured and sent to the foundation model. Session management further decouples a user's conversational state from the foundation model's session state. These concepts and others may be used to emulate e.g., a chatbot based virtual assistant that responds based on user context.

### PRIORITY

This application claims the benefit of priority to U.S. Provisional Patent Application Ser. No. 63/508,650 filed Jun. 16, 2023 and entitled “NETWORK INFRASTRUCTURE FOR USER-SPECIFIC GENERATIVE INTELLIGENCE”, and U.S. Provisional Patent Application Ser. No. 63/565,974 filed Mar. 15, 2024 and entitled “LARGE LANGUAGE MODEL PIPELINE FOR REAL-TIME EMBEDDED DEVICES”, each of the foregoing incorporated by reference in their entirety.

### RELATED APPLICATIONS

This application is related to U.S. patent application Ser. No. 18/061,203 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/061,226 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/061,257 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/185,362 filed Mar. 16, 2023, and entitled “APPARATUS AND METHODS FOR AUGMENTING VISION WITH REGION-OF-INTEREST BASED PROCESSING”, U.S. patent application Ser. No. 18/185,364 filed Mar. 16, 2023, and entitled “APPARATUS AND METHODS FOR AUGMENTING VISION WITH REGION-OF-INTEREST BASED PROCESSING”, U.S. patent application Ser. No. 18/185,366 filed Mar. 16, 2023, and entitled “APPARATUS AND METHODS FOR AUGMENTING VISION WITH REGION-OF-INTEREST BASED PROCESSING”, U.S. patent application Ser. No. 18/316,181 filed May 11, 2023, and entitled “METHODS AND APPARATUS FOR SCALABLE PROCESSING”, U.S. patent application Ser. No. 18/316,214 filed May 11, 2023, and entitled “METHODS AND APPARATUS FOR SCALABLE PROCESSING”, U.S. patent application Ser. No. 18/316,206 filed May 11, 2023, and entitled “METHODS AND APPARATUS FOR SCALABLE PROCESSING”, U.S. patent application Ser. No. 18/316,218 filed May 11, 2023, and entitled “APPLICATIONS FOR ANAMORPHIC LENSES”, U.S. patent application Ser. No. 18/316,221 filed May 11, 2023, and entitled “APPLICATIONS FOR ANAMORPHIC LENSES”, U.S. patent application Ser. No. 18/316,225 filed May 11, 2023, and entitled “APPLICATIONS FOR ANAMORPHIC LENSES”, U.S. patent application Ser. No. 18/316,203 filed May 11, 2023, and entitled “APPLICATIONS FOR ANAMORPHIC LENSES”, U.S. patent application Ser. No. ______ filed ______, and entitled “NETWORK INFRASTRUCTURE FOR USER-SPECIFIC GENERATIVE INTELLIGENCE”, U.S. patent application Ser. No. ______ filed ______, and entitled “NETWORK INFRASTRUCTURE FOR USER-SPECIFIC GENERATIVE INTELLIGENCE”, U.S. patent application Ser. No. ______ filed ______, and entitled “NETWORK INFRASTRUCTURE FOR USER-SPECIFIC GENERATIVE INTELLIGENCE”, U.S. patent application Ser. No. ______ filed ______, and entitled “NETWORK INFRASTRUCTURE FOR USER-SPECIFIC GENERATIVE INTELLIGENCE”, each of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of cloud computing infrastructure for generative intelligence. More particularly, the present disclosure relates to systems, computer programs, devices, and methods that may be improved by providing user context to a generative intelligence system.

### DESCRIPTION OF RELATED TECHNOLOGY

Generative intelligence, also known as generative artificial intelligence (AI), refers to a class of AI models and algorithms that are designed to create new content, such as images, text, music, and even videos, by learning patterns and structures from existing examples.

A large language model (LLM) refers to a type of generative artificial intelligence model designed to generate human-like language. LLMs are trained to learn patterns, context, and word relationships, from vast amounts of text data. The trained LLM then generates a novel sequence of words for an input prompt, based on its training. LLMs have been used for a variety of natural language processing tasks, including text generation, translation, summarization, and question-response interactions. Conventional LLMs have a massive number of parameters, which enables them to capture complex linguistic patterns and generate coherent and contextually relevant text.

Providing user-specific data to cloud-based LLMs are complicated by a variety of factors (e.g., privacy, security, cost, etc.). This limits the full potential of cloud-based LLMs for user-specific applications. As a related consideration, embedded devices are often constrained by their onboard resources; in other words, power consumption, size, performance, etc. are often limited. Embedded devices may not have the localized capability to fully support user-specific LLM applications.

As a related note, a large multi-modal model (LMM) can be thought of as a generalization or evolution of the LLM architecture. Instead of using language-based tokens, LMMs use tokens for different modalities of data. For example, patches (portions of an image) from a video codec may be treated as input tokens. Similarly, linear data (e.g., audio from microphones and/or inertial data from inertial measurement units (IMUs)) may be used as tokens. LMMs are still in development, but will encounter similar challenges for user context.

More generally, new solutions are needed to accommodate the rapid growth of user-specific applications for generational intelligence technologies.

### BRIEF DESCRIPTION OF THE DRAWINGS

FIG. 1 is a ladder flow diagram of conventional large language model (LLM) operation.

FIG. 2 presents an example of LLM operation, useful to explain LLM operation.

FIG. 3 presents a typical transformer architecture 300, useful to explain transformer operation.

FIG. 4 is an exemplary ladder flow diagram for user-initiated generative intelligence interactions.

FIG. 5 is a graphical representation of a usage scenario, useful to explain various aspects of the present disclosure.

FIG. 6 is a graphical representation of a first transaction with an exemplary virtual assistant chatbot application, useful to explain various aspects of the present disclosure.

FIG. 7 is a graphical representation of a second transaction with an exemplary virtual assistant chatbot application, useful to explain various aspects of the present disclosure.

FIG. 8 is a first exemplary ladder flow diagram for layered data transactions, useful to explain various aspects of the present disclosure.

FIG. 9 is a second exemplary ladder flow diagram for layered data transactions, useful to explain various aspects of the present disclosure.

FIG. 10 is a graphical representation of session persistence for user-specific information, useful to explain various aspects of the present disclosure.

FIG. 11 is a graphical representation of a third transaction with an exemplary virtual assistant chatbot application, useful to explain various aspects of the present disclosure.

FIG. 12 is a graphical representation of a transaction with a generically trained LLM chatbot application, useful to illustrate the limitations and capabilities of conventional LLM chatbot applications.

FIG. 13 is a graphical representation of a fourth transaction with an exemplary virtual assistant chatbot application, useful to explain various aspects of the present disclosure.

FIG. 14 is a graphical representation of a transaction with a generically trained LLM chatbot application, useful to illustrate the limitations and capabilities of conventional LLM chatbot applications.

FIG. 15 is a graphical representation of a fifth transaction with an exemplary virtual assistant chatbot application, useful to explain various aspects of the present disclosure.

FIG. 16 is a logical block diagram of one exemplary system architecture.

FIG. 17 is a logical block diagram of the exemplary edge device.

FIG. 18 is a logical block diagram of the exemplary aggregator device.

FIG. 19 is a logical block diagram of the exemplary cloud service.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1 Computer-Vision Processing

Computer vision refers to the field of artificial intelligence and computer science that enables computers to interpret and understand the visual world. Incipient research is directed toward algorithms and techniques that can extract information from digital images or videos, and then use that information to make decisions or take actions. Computer vision applications are used in a wide range of industries and fields, including healthcare, automotive, surveillance, entertainment, and robotics. Some common examples of computer vision applications include object detection, object recognition, captioning, etc.

Different aspects of computer vision analysis may provide different functionality and/or types of information, etc. For example, a first scale of computer vision analysis might perform object detection whereas a second scale might implement object recognition. “Detection” and “recognition” are two related but distinct technologies that involve analyzing images or video footage of faces. Detection refers to the process of identifying the presence of an object in an image or video. It involves detecting the location, size, and orientation of the object within an image or video frame, and it can be used for a variety of purposes such as focusing a camera on an object, tracking the movement of an object, or detecting how many objects are in an image. Recognition, on the other hand, involves identifying a specific object from a library of candidates by comparing the object's features to corresponding features of the candidate objects. For example, within the context of facial recognition, the computer-vision algorithm might analyze various characteristics of a face, such as the distance between the eyes, the shape of the nose and mouth, and the contours of the face, to create a unique “faceprint” that can be compared against a database of known faces.

As a practical matter, object detection and object recognition have different goals, design trade-offs, and applications. For example, the error rates (either false positive/false negatives) in object detection and object recognition can vary depending on a variety of factors, including the quality of the technology, the environment in which it is being used, and the specific application of the technology. In general, error rates in object detection (˜1-2%) tend to be far less common than object recognition (10-20%), for similar processing complexity and/or power consumption.

“Captioning”, specifically image captioning, is the task of generating a textual description that accurately represents the content of an image. It goes beyond mere object recognition by providing a more comprehensive and contextual understanding of the image. Image captioning models typically combine object detection and/or recognition with natural language processing techniques to generate captions that describe the scene, objects, and their relationships.

### 2 Natural Language Processing and Large Language Models

Natural Language Processing (NLP) is a subfield of artificial intelligence (AI) that focuses on the interaction between computers and human language. It involves the development of algorithms and techniques to enable computers to understand, interpret, and generate human language in a way that is meaningful and useful.

Recent advances in NLP have created so-called “large language models” (LLMs). LLMs are built using a significant amount of computational resources, training data, and parameters. These models are designed to process and generate human language and exhibit a high level of language understanding and generation capabilities. One LLM application that has ignited interest in generative intelligence is chatbot-type applications (such as CHATGPT™ and its various versions e.g., GPT-3, GPT-3.5, GPT-4, as well as other implementations such as LLaMA (Large Language Model Meta AI), etc.).

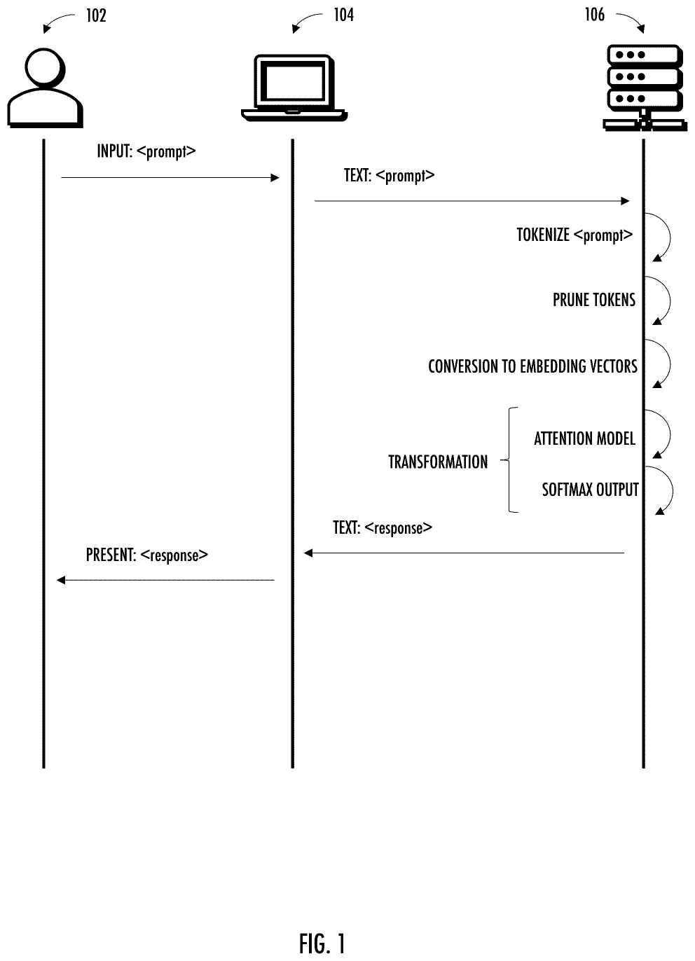

FIG. 1 is a graphical representation of conventional large language model (LLM) operation. As shown, a user 102 provides an input prompt to a client device 104 (e.g., a laptop); for example, a user 102 might type in their prompt, or provide a vocal instruction (the client device 104 may use speech-to-text software to obtain the text prompt). The client device 104 sends the text prompt to the LLM 106. The LLM 106 might perform several distinct steps: tokenization, token pruning, conversion to embedding vectors, and transformation (which includes an attention model for natural language processing and word selection).

While the illustrative model of FIG. 1 is presented with a specific logical topology, artisans of ordinary skill will readily appreciate that a variety of different physical topologies exist. For example, the functionality of client device 104 might actually be split across multiple devices. Similarly, the functionality of the LLM 106 might be physically localized within a client device 104, etc.

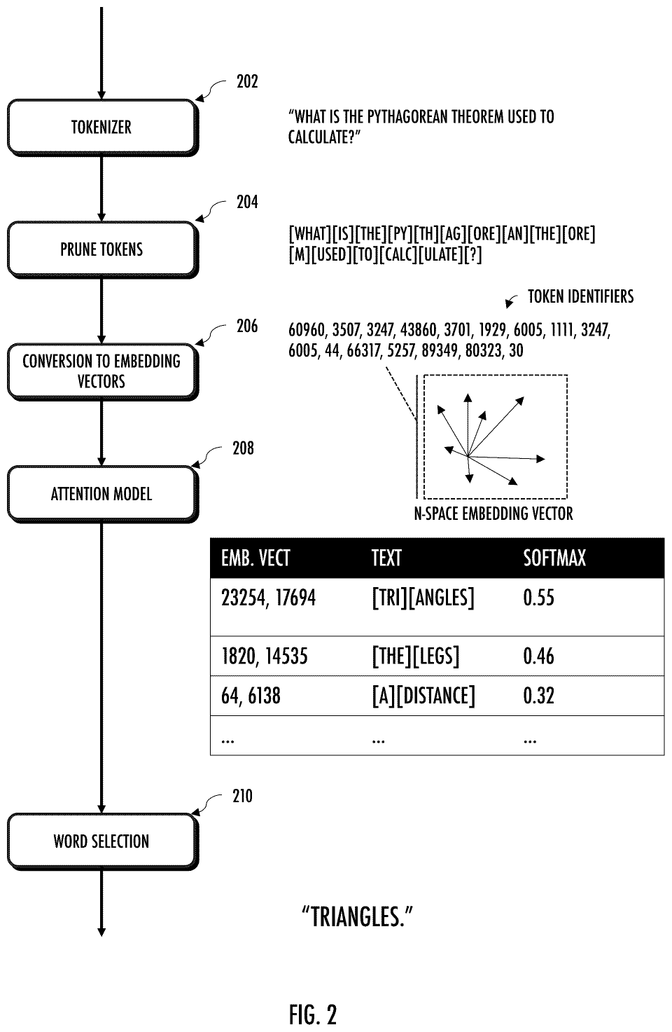

FIG. 2 presents an example of LLM operation, useful to explain LLM operation. At step 202, the input prompt is tokenized. Tokenization is the process of breaking down a sequence of text into smaller units called tokens. Tokens are typically words, sub-words, and even individual characters. For example, a word like “eating” might be represented as two tokens “eat” and “ing”. Tokenization is highly language and context dependent. Empirical evidence suggests that 750 English words corresponds roughly to about 1000 tokens (or about 1 token for every 4 letters). There are special tokens that may have specific meaning to the LLM; for example, many LLMs have “start”, “separator”, “pause”, and “stop” tokens to implement different types of data control within the natural language framework. Importantly, each token is mapped (usually one-hot) to a token identifier (token ID) that uniquely identifies an embedding vector in high dimensional space or control instruction that an LLM has been trained for. For example, an LLM might recognize ˜80,000 unique token identifiers (token IDs).

As a practical matter, conventional LLMs impose a token limit to ensure that computational demands do not exceed the models' capabilities. The token limit is the maximum number of tokens that can be processed by the model to generate a response. Since the LLM maintains a running session state (also referred to as a “context window”), a token limit of e.g., 4096 tokens would correspond to roughly 3000 words of dialogue held in working memory. Notably, both the user's prompts and the model's responses count toward the token limit. If a session exceeds the token limit, then tokens are pruned based on e.g., recency, priority, etc. (step 204).

At step 206, each token is converted to its corresponding embedding vector. In the context of natural language processing (NLP) and machine learning, an “embedding vector” is a numerical representation of a word or a token in a high dimensional vector space. It captures the semantic and syntactic relationships between words, allowing machine learning models to understand and process textual data. For example, an LLM might use embedding vectors with e.g., 384 dimensions.

In slightly more detail, a machine learning model is trained on a large corpus of text data, such as sentences or documents. The model learns to represent each word as a dense vector in a high-dimensional space, where words with similar meanings or contexts are closer to each other in the vector space. In some cases, embedding vectors may additionally be used as part of the training process to customize the machine learning model. Here, “high dimensional space” refers to anything higher than physical space (e.g., 3 or 4 dimensions)—for machine learning applications, this is typically tens, hundreds, thousands, etc. of dimensions.

Embedding vectors have several advantages in natural language processing (NLP) tasks. They represent the meaning and context of words as numeric vectors, which enables models to perform arithmetic operations. Addition, subtraction, and dot products (projections) of embedded vectors can be used to find relationships between words. For instance, subtracting a “male” vector from a “son” vector and adding a “female” vector would result in a vector that closely approximates (or identically matches) a “daughter” vector.

Referring back to FIG. 2, an “attention model” takes the array of embedding vectors and generates a number of possible responses at step 208 using a “transformer” model. Transformer models are a type of deep learning first introduced in “Attention is All You Need” by Vaswani et al. in 2017, incorporated by reference in its entirety. Transformer models generally include multiple layers of encoding, decoding, and self-attention logic.

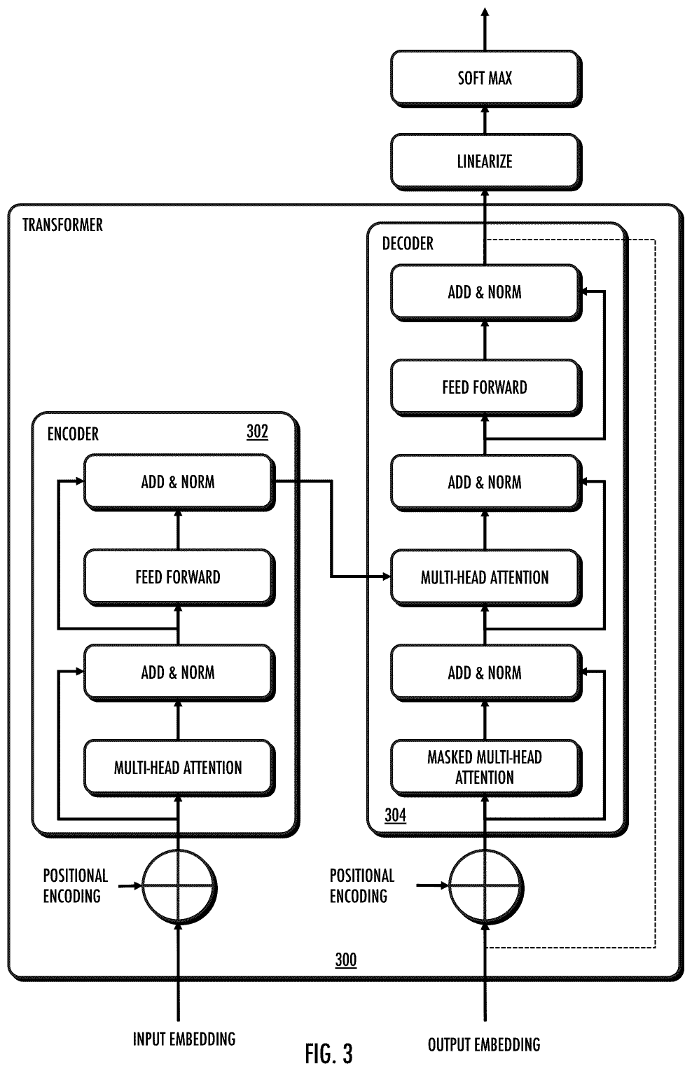

FIG. 3 presents a typical transformer architecture 300. The transformer is split into an encoder 302 and a decoder 304. The encoder 302 extracts relevant information from the input prompt, the decoder 304 uses the relevant information to generate possible outputs (transformations).

Transformer models are based on the concept of “attention”. Certain words have more significance in shaping the context and a meaning in the sentence. Here, attention refers to the process of assigning contextual information to tokens (words) in view of the entire sequence of tokens (the sentence). For example, a single-headed attention mechanism might assign 3 vectors to each token: query (Q), key (K), and value (V). These vectors are derived from the embeddings of the tokens. Each token is then given an attention score by taking the dot product of its query (Q) vector with the key (K) vectors of all other tokens. These scores reflect the importance of the token relative to the other tokens. The attention scores are then normalized to different probabilities. These probabilities correspond to the weight that each token's Value (V) vector contributes to the final output. The weighted sum of the Value (V) vectors, based on the probabilities, forms the output for each token. This output represents both local and global contextual information but does not provide enough complexity to mimic human speech.

So-called “multi-head attention” uses multiple single-headed attention mechanisms in parallel to process multiple relationships and patterns within the sequence. Each attention head focuses on different aspects of the input; the results are combined to mimic the linguistic complexity of human speech patterns.

Referring first to the encoder 302, input embedding vectors are first weighted according to positional encoding, which weights each word (token) according to its position in the sentence (input sequence). The resulting vectors are then encoded through multi-head self-attention layer, followed by an “add & normalize” operation which performs layer normalization and adds the original embeddings via a skip connection (also known as a residual or shortcut connection). The result is then provided to a feed forward neural network; typically, a multilayer perceptron of multiple fully connected layers with nonlinear activation functions. The outputs are then added and normalized again before being provided to the decoder 304.

The decoder 304, uses a very similar structure to the encoder 302 (e.g., multi-headed self-attention layer, add & norm, feed-forward, add & norm), however the output of the decoder 304 is fed back through a masked multi-headed self-attention layer and add & norm step. The masked multi-headed self-attention layer masks off portions of the generated target sequence, such that the decoder does not “peek ahead” when predicting the next word. This allows the decoder to generate a target sequence that mimics human speech in both contextual relevance and semantics.

Referring back to FIG. 2, the output of the transformer is a listing of embedding vectors (corresponding text translations shown for illustration) along with a likelihood (e.g., a softmax value). These results are passed through selection logic, which might include additional parameterizations to adjust word selection (step 210). For example, many LLMs incorporate a “temperature” parameter that regulates the unpredictability of a LLM's output. With higher temperature settings, outputs become more creative and less predictable (amplifies the likelihood of less probable tokens), whereas lower temperatures provide less variability (e.g., word repetition, etc.).

There are some practical drawbacks to LLMs. LLMs often do not have access to timely and/or accurate information. A generative AI or chatbot can “hallucinate”—i.e., providing an answer that is factually incorrect or irrelevant because of limitations in its training data and architecture. Unfortunately, these hallucinations are often difficult to discern from normal output. Processing and training costs for LLMs are also substantial. While LLMs may be made freely accessible to the public for research, estimates suggest that each LLM query costs several cents. Training an LLM costs millions of dollars. As a practical matter, these costs are prohibitive for mass produced consumer electronics applications. Even if cost was not a limitation, user-specific data sets often include highly sensitive personal information. Additionally, user-specific data is fluid and often changes based on time and location. Continuously training and/or re-training an LLM for user-specific data sets is impractical. Finally, while LLMs can preserve conversational context during a session, the session data is destroyed once closed. Each session only has one set of initialization and pre-prompt data. However, humans can dynamically start, end, and maintain multiple different conversational contexts.

### 3 Exemplary User-Specific Generative Intelligence System

Various aspects of the present disclosure provide user-specific data to large language models (LLMs), large multi-modal models (LMMs), and/or other foundation models. Conceptually, by giving “eyes” (image information) to LLM-based chatbots, the chatbot can access a much richer context (via computer vision analysis) that was not expressly input by the user. Conceptually, this would enable a chatbot to answer questions with user-specific information that is relevant, timely, and/or factual (rather than based on generalized training data).

Unfortunately, providing user-specific context to a generically trained LLM introduces a variety of complications. First, LLMs are trained on libraries of text data that are unrelated to any particular person; the resulting tokens/embedding vectors are generic, and do not include user-specific information. While the LLM may infer user-specific information during a session, this inferred information may be pruned as the session persists and will be deleted when the session is closed. This may be particularly problematic for mobile devices which may not be able to maintain a session due connectivity issues and/or may juggle multiple concurrent user-specific contexts. Exemplary embodiments of the present disclosure handle user-specific data outside of LLM sessions; user-specific data may be used to initialize and/or feed information to the LLM session as a personalization state. Furthermore, the personalization state concepts may be broadly extended to emulate other types of session persistence.

Secondly, privacy and security are key considerations in many connected applications. Access control may be particularly important to prevent unauthorized device operation (e.g., capturing audio, images, location, etc. without the user's permission) and/or usage of user-specific data. Conversely, excessive privacy notifications and/or similar requests for consent may be inconvenient and undesirable. Exemplary embodiments of the present disclosure impose different access restrictions on different nodes of the device ecosystem, this minimizes transfers of sensitive user data and also avoids unauthorized access.

Thirdly, power consumption and resource utilization (e.g., bandwidth, processing cycles, memory, etc.) are often heavily constrained in consumer electronics devices. Capturing, storing, and/or transacting large amounts of data is impractical for everyday usage. Exemplary embodiments of the present disclosure implement “layers” of data that can be used for different types of tasks. For example, a first layer of data may include captured (sensed) data that is used to encode sensory information. A second layer may include “working memory” that is used to identify and/or infer contextual information. A third layer may be used to index, store, search and/or recall events.

As a brief aside, most software is explicitly programmed to perform a specific function, expect specific input/output data, etc. For example, unexpected data types may result in compile-time or run-time errors. However, LLMs, foundation models, and other generational intelligence emulate a generational intelligence model that is trained on data, and that adapts its training according to input data; they are not explicitly programmed to perform any task or function beyond the modeling, per se, instead tasks may be inferred from its input data and/or training.

While the benefits of offloading computations to cloud resources for embedded devices are well known in the computing arts, the unique nature of LLMs, foundation models, and other generational intelligence introduce novel issues of resource management for cloud computing environments. Cloud computing enables (but heavily penalizes) inefficient resource use. Not all tasks require (or are even well-served by) the capabilities of general intelligence, yet there is significant interest in adapting their flexibility to human-centric interfaces which are difficult to predict and design-for. For example, a user query may be better handled with conventional search as opposed to an LLM-powered chat session. Exemplary embodiments of the present disclosure implement an intermediary service that performs resource allocation; this intermediary service appropriately re-directs queries to different resources, avoiding unnecessary resource allocation.

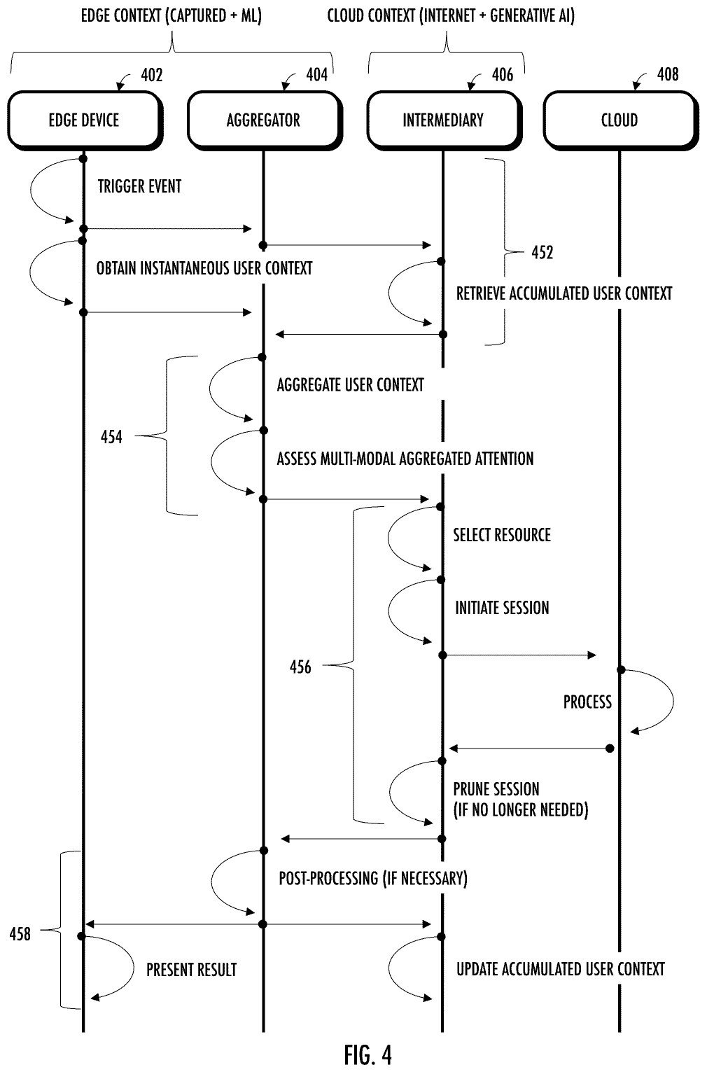

Referring now to FIG. 4, an exemplary ladder flow diagram for user-initiated generative intelligence interactions is shown. Here, a user has a set of user devices (e.g., smart glasses 402 and/or a smart phone 404) in communication with an intermediary cloud service 406, which may communicate with external cloud resources 408. Here, the system is divided into multiple different stages: edge capture (smart glasses 402), aggregation (smart phone 404), resource selection (intermediary cloud service 406), and external cloud resources 408 (which may include one or more of foundation models, internet resources, and/or other user devices/databases). The exemplary ladder diagram is purely for illustration—other implementations may combine, divide, hybridize, and/or augment functionalities within different entities and/or topologies (e.g., the smart phone may be an edge device, the intermediary cloud service may perform aggregation, etc.).

During online operation, the smart glasses 402 and smart phone 404 capture instantaneous user context (steps 452). In some cases, the smart glasses 402 may be triggered to collect information about the user's activity and intent. For example, the smart glasses 402 may incorporate a microphone to capture sound (including user speech), eye-tracking cameras to monitor user gaze, “always-on” cameras to monitor the external environment (at low resolution (e.g., 1080p), low frame rates (e.g., 30 fps), etc. to save power), forward-facing cameras to capture the user's forward view (at high resolution (e.g., 4K), high frame rates (e.g., 60 fps) for image processing, etc.), etc. Similarly, the smart phone 404 may have access to internet activity, communications, and/or global positioning system (GPS) and inertial measurement units (IMU) to provide location and/or movement data. The smart phone 404 may also receive edge context from the smart glasses 402 (and any other edge devices e.g., smart watches, smart vehicles, laptops, etc.).

In some variants, the intermediary cloud service 406 may also provide relevant accumulated user context. For example, the intermediary cloud service 406 may use the user's location information to identify relevant user activity and intent based on the user's previous history at the location. Similarly, visual detection/recognition (e.g., faces, objects, etc.) and verbal cues may be used to identify potentially relevant information from previous activity, etc.

As used herein, the term “context” broadly refers to a specific collection of circumstances, events, device data, and/or user interactions; context may include spatial information, temporal information, and/or user interaction data. In some embodiments, context may be person-specific, animal-specific, place-specific, time-specific, or other tangible/intangible object-specific. “User context” refers to context information that is specific to the user. “Instantaneous user context” refers to user context that is specific to a specific instant of time. “Accumulated user context” refers to user context that has been collected over the user's usage history. In some cases, accumulated user context may additionally weight information based on age, repetition, and/or other confidence metrics.

As used herein, the term “online” and its linguistic derivatives refers to processes that are in-use or ready-for-use by the end user. Most online applications are subject to operational constraints (e.g., real-time or near real-time scheduling, resource utilization, etc.). In contrast, “offline” and its linguistic derivatives refers to processes that are performed outside of end use applications. For example, within the context of the present disclosure, user prompt augmentation is performed online whereas updating and processing cloud context (described elsewhere) may be performed offline.

As used herein, the term “real-time” refers to tasks that must be performed within definitive time constraints; for example, smart glasses may capture each frame of video at a specific rate of capture. As used herein, the term “near real-time” refers to tasks that must be performed within definitive time constraints once started; for example, smart glasses may perform object detection on each frame of video at its specific rate of capture, however some variable queueing time may be allotted for buffering. As used herein, “best effort” refers to tasks that can be handled with variable bit rates and/or latency.

The instantaneous user context and/or accumulated user context may then be aggregated and/or assessed to determine the user's current context at the edge (edge context) at steps 454. In one exemplary embodiment, the user context may combine multiple different modalities of information—e.g., audio information, visual information, location information, etc. Different modalities of information may be converted first to a domain space that allows for their direct comparison—for example, in the context of a large language model (LLM) the different modalities of information may first be converted to a common comparison domain (text), via e.g., image-to-text, speech-to-text, etc.

In some cases, the smart glasses and/or smart phone may have on-device captioning logic which implements image-to-text functionality. The captioning logic may take an input image and generate one or more labels. In some cases, the labels may be text; in other implementations, the labels may be tokens and/or embedding vectors. In some cases, the captioning logic may also identify certain characteristics of the image (e.g., indoors/outdoors, near/far, etc.).

More generally, the conversion-to-text functionality may broadly encompass any logic configured to generate text data from other modalities of data; this may include e.g. optical character recognition and/or other forms of image analysis logic. Similar concepts may be used for speech-to-text, audio-to-text (e.g, the sound of a dog barking may be used to generate text “a dog barking”), location-to-text (e.g., the location may be used to generate a text description of location), etc.

In some variants, edge capture may be performed according to a static procedure (e.g., voice command, triggers gaze point detection, triggers location tracking, etc.). In other variants, the information may be selectively gathered depending on the type and/or nature of edge context (e.g., verbal prompts, user interactions (gestures, gaze point, etc.), location data, object recognition, etc.). For example, a person that asks “Who is that?” might trigger a subsequent facial detection process at or near the user's gaze point; a person that asks “What is this?” might trigger an object detection process at or near the user's gaze point, etc. Similarly, a person that stares at a person's face (or object) might trigger subsequent detection/recognition processing. In other words, any number of subsequent processing and/or other supplemental edge capture may be triggered before and/or during the aggregation step.

Consider a scenario where the user verbally asks a question. The smart glasses 402 may capture the audio waveform locally and convert the speech to text to create a text prompt. In some cases, the smart glasses 402 may also gather contextual information about the user, their environment, and/or objects of interest, that may be useful to augment the user prompt. As but one such example, smart glasses 402 may use eye-tracking cameras and/or forward-facing cameras to obtain gaze information, and/or other data (e.g., location and/or movement data.). In addition, the smart phone 404 may also be tracking the user's location and/or monitoring the user's online activity, etc.

Under these circumstances, the smart phone 404 may determine that the user is perusing the aisles of a grocery store based on location tracking information. The smart glasses 402 may detect that the user has fixed their gaze on a milk carton, the edge devices may then interpret the gaze fixation in view of the location (store) and target (milk), to be phrased as a text-based question: “Do I need to buy more milk?” Importantly, this text-based conversion may be predicted from the context, even without an explicit verbal prompt or textual input. Instead, the contextual clues can be used to infer a “user story” e.g., the user is doing grocery shopping and trying to determine whether they have that item already. In the text-based domain, the system may use an LLM to interpret the user story, find and process the relevant data (e.g., check the user's food at home), and generate the appropriate response. In other words, the user prompt may be wholly device-generated depending on context.

More broadly, the smart phone 404 may aggregate and assess multiple different modalities of information to determine the nature of the user's attention. Assessment may be performed based in a single modality (e.g., a text-based LLM), a multi-modal model (large multi-modal models (LMMs)), generative intelligence model, or any other foundation model. So-called “foundation models” are artificial intelligence models that are capable of adapting to a variety of data and applications beyond what the models were trained for. In other words, they provide the “foundation” on which other applications may be built. Typically, they're characterized by transfer learning; i.e., the model accumulates internal “knowledge” and applies information from one situation to another. As previously alluded to, foundation models represent data in a manner that facilitates this level of flexibility. For example, within the context of LLMs, words are represented with tokens/embedding vectors in a high dimensional space.

While LLMs are the most widely available foundation model, future implementations will likely incorporate and intertwine other modalities of data. For example, image-based models may use images and/or videos, etc. In some cases, the images and/or video may additionally be embedded with reference to other text, audio, visual, and/or other forms of data. While these large multi-modal models have not yet achieved the maturity that LLMs have, the concepts described throughout may be broadly applied to such implementations as well.

Referring back to FIG. 4, the smart phone 404 may have sufficient resources and/or capabilities to directly respond (not shown) with its own local resources (e.g., a local LLM); however, in the depicted transaction, additional resources are needed-thus, the smart phone 404 launches supplemental queries to the intermediary cloud service 406.

At step 456, the intermediary cloud service 406 performs network resource selection and/or session management based on the multi-modal aggregated attention. The intermediary cloud service 406 may have additional access and/or resources that the smart phone 404 does not; for example, the intermediary cloud service 406 may have access to larger compute, more memory, other user devices (or the devices of the user's social group), and/or a longer history of user interactions than the smart phone; thus, the intermediary cloud service 406 can select and appropriately re-direct (if necessary) the most applicable network resource.

As previously mentioned, different user queries may or may not be best served with generative intelligence. As but one such example, a smart phone-based LLM may be “data limited” rather than “functionally limited”-when provided with appropriate data, the smart phone-based LLM may be able to provide acceptable answers. In such cases, the intermediary cloud service 406 need only provide the smart phone-based LLM with access or information from a suitable data reference (e.g., a user database, an internet-accessible resource, etc.). In some cases, a user may not even need LLM functionality beyond parsing the spoken language input; the user may want to perform an action (pin a location, post to social media, etc.), want a news article directly read back (rather than e.g., summarized through an LLM), etc.

Where information from a session-based interaction is needed, the intermediary cloud service 406 may additionally operate as an intermediary between the smart phone 404 and the external cloud resources 408. In this capacity, the intermediary cloud service 406 may handle creation, maintenance, and tear-down of a backend session with the external cloud resources 408. Importantly, the relevant information from the backend session may be extracted and provided to the smart phone 404 (or other aggregator), such that the smart phone 404 does not need to manage the backend session itself.

While the following examples are discussed in the context of an LLM session, the intermediary cloud service 406 may broadly extend session management to a variety of other cloud-based services. Examples may include e.g., media delivery, social networking, location-based tracking, etc. Unlike typical client-server interactions, the exemplary embodiments allow a user to directly interface to the internet via a small localized LLM (e.g., running via the smart phone 404). The user does not directly interact with the backend sessions, rather, they are accessed on behalf of the user by the intermediary cloud service 406. Under this paradigm, session state may be created as needed, and aggressively pruned as soon as the user's attention has shifted elsewhere (as opposed to waiting for a session timeout, etc.).

Consider, as one illustrative example, an LLM's session state (context window) that defines the text sequence that is used to generate the response. The LLMs own responses form part of the context window; this is needed so that the LLM remains self-consistent. In practical application, however, the context window is handled by the LLM and may be pruned without notice and/or contain stale information (due to a sudden shift in user context, etc.). In order to maintain a self-consistent context window, the intermediary cloud service 406 may locally store and manage a separate “conversation state” to refresh and/or update information as needed between queries. In some cases, conversation state may also incorporate and/or coordinate with query construction at the smart phone 404.

Here, the “conversation state” is limited to the context that corresponds to interactions with the user. In other words, the conversation state is limited to the previously selected responses and the queries that were used to generate it. Importantly, the conversation state excludes information was previously generated but not used. This may occur where e.g., multiple different network resources are used but only one is selected, etc.

The intermediary cloud service 406 (or even the smart phone 404) can construct queries (“query construction”) so that the LLMs' session state (context window) matches the relevant portion of the conversation state. For example, the relevant portions of the conversation state may be based on recency. In one such implementation, an LLM with a token limit of 4096 might only need the 4096 most recent tokens of the user's conversation state. More complex implementations may consider the user's input and/or surroundings (e.g., relevant subject matter, region-of-interest, gaze point, etc.). For example, the query constructor might filter conversation state based on what the user is talking about and/or looking at. More generally, any information that corresponds to the user's state of mind and/or intent may be used to select the most relevant portions of the conversation state with equal success.

Different LLMs have different token limits, knowledge bases, and/or training and may need different portions of conversation state. For example, a large LLM may receive much more conversational state (e.g., 16K tokens) versus a small LLM (e.g., 4K tokens), etc. Furthermore, different LLMs have different tokenization and/or respond to different types of prompt engineering. In other words, the query constructor may need to separately fashion different queries based on each LLM's capabilities.

While the foregoing examples are presented in the context of a text-based chat session, other LLMs may directly expose session state (or context window) information via an API (application programming interface) or similar communication protocol; in such implementations, the query constructor may prime the session state directly via the API.

The intermediary cloud service 406 may maintain multiple conversation states. Conceptually, this enables multi-tasking across multiple different user contexts. For example, a user at work may be interrupted by a personal errand and quickly need to change to a separate user context. When the user returns to the work context, their personal context can be switched back out. Much like session persistence, this functionality may also be handled at the smart phone 404 (or other aggregator device), to the extent that the device has access to the relevant resources and data.

Where session-based resources are utilized, the intermediary cloud service 406 may actively monitor and prune inactive sessions. For example, multiple queries may be launched to models of different complexity; while a simple model can answer more quickly, the complex model may answer more accurately. As another such example, multiple queries may be launched to LLMs with access to different libraries of information. The high cost of these parallelized queries may be offset with session pruning.

Referring back to FIG. 4, the intermediary cloud service 406 provides the information from backend session to the smart phone 404 (step 458). The smart phone 404 may then perform post-processing to provide the relevant information to the user via e.g., its own local LLM. In addition, the local conversation state may be updated once the LLM generates the resulting response. Importantly, the conversation state is updated based on only the selected response and its corresponding query; unused information is discarded. In simple embodiments, conversation state may be stored as a text dialogue. In other implementations, the conversation state may be represented as a set of tokens, embedding vectors, and/or any other representation of the conversation state.

As an important aside, the local LLM of the smart phone may be constrained to singular response presentation. Text responses can be presented, and then updated with new information. Eyes can quickly glance at different portions of text in a non-sequential manner; this allows the user to skip to only the portions that have changed, etc. However, text-to-speech is read start-to-finish and cannot be “unheard”; reading a first response, and then correcting the response based on a later information, is cumbersome/infeasible.

Lastly, accumulated user context information may be “stitched” together at the smart phone 404 or within the intermediary cloud service 406 to create a large database of “persona” information. For both privacy and complexity reasons, external cloud resources 408 (e.g., 3^{rd} party large language model (LLM), social networks, internet, etc.) may not have unlimited access to the “persona” information.

The following discussions explore certain aspects of the exemplary user-specific generative intelligence system discussed above.

### 3.1 Exemplary User-Specific Embedding Vectors

Exemplary embodiments of the present disclosure enable user-specific embedding vectors external to underlying LLM machination. Here, the edge devices capture instantaneous user context in a variety of modalities (e.g., images, text, speech, etc.); the aggregator converts the edge information into a persistent history of user context with user-specific embeddings (e.g., “my keys”, etc.). Later, the user may make inquiries against their persistent history using the local LLM, or cloud resources via an intermediary—notably, the record of interactions does not require a persistent LLM session (or any other networked resource) to be constantly tracking the user.

While the following example is presented in the context of a user wearing smart glasses in communication with a smart phone, the concepts may be broadly extended to a variety of user devices (smart watches, laptops, smart jewelry, and/or any other user device in the mobile ecosystem).

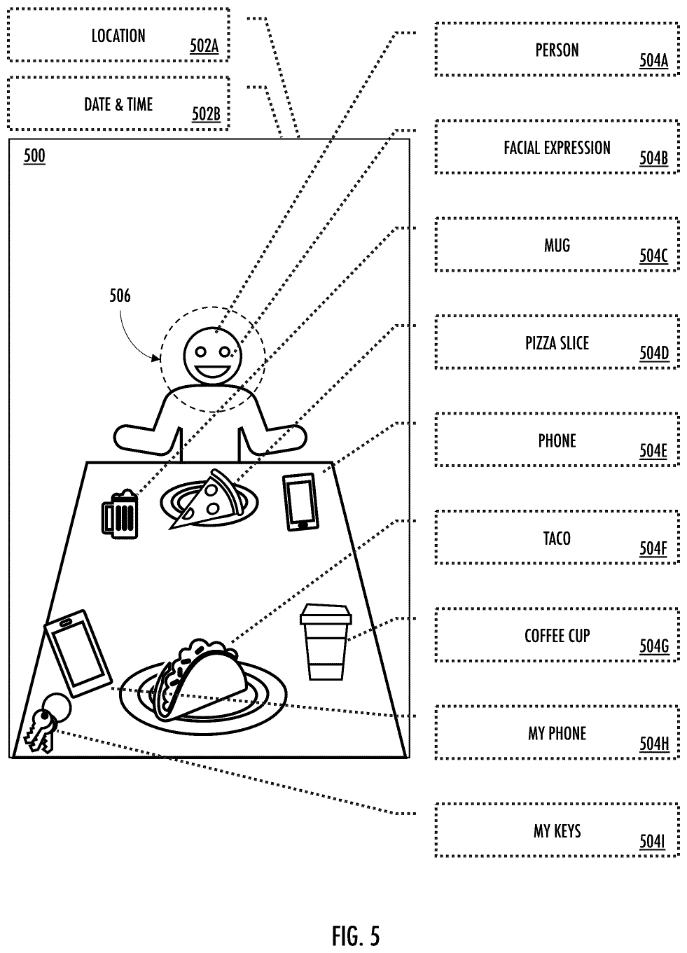

Consider the scenario illustrated in FIG. 5. As shown, an image 500 with a person 506 is captured based on user intent. The image may be associated with the time and location of capture e.g., location 502A and date/time stamp 502B. In this example, the identified captions include: a person 504A, a facial expression 504B, a mug 504C, a pizza slice 504D, a phone 504E, a taco 504F, and a coffee cup 504G.

In one embodiment, the identified captions that are derived from the images are mapped to embedding vectors. These embedding vectors may later be provided to an LLM-based chatbot. Unlike existing LLM-based chatbots which only interact via text, the images (e.g., provided by smart glasses) allow the LLM-based chatbot to “see” the world that the user is referring to.

In some implementations, certain objects may additionally have user-specific captions; for example, the user's phone is identified as “my phone” 504H and the user's keys are identified as “my keys” 504I. As previously noted, a generically-trained embedding vector for “keys” allows an LLM to distinguish between different lexical uses of keys e.g., door keys, musical keys, key concepts, cryptographic keys, and/or any other generic usage of the term “key”. However, adding the user-specific embedding vector for “my keys” allows user-specific data to be considered without re-training the LLM. For example, the smart glasses may passively observe the user's keys throughout the user's day-to-day activities. Earlier, the smart glasses may have detected the user's keys on a kitchen counter. This may be stored by adding a first “location” vector to associate the “kitchen counter” vector with the “my keys” vector. Then, the smart glasses may identify the user's keys on the table at a restaurant (see e.g., “my keys” caption 504I of FIG. 5); the smart glasses may update the location by subtracting the first “location” vector from the “my keys” vector and adding a second updated “location” vector to associate the “restaurant” vector with the “my keys” vector.

Later, having forgotten where they placed their keys, the user asks their smart glasses for the location of their keys (“where are my keys?”). In response, the smart glasses provide the “my keys” embedding vector to an LLM as initialization data; the LLM determines that question is focused on “my keys” rather than “keys”; by subtracting the “keys” vector from the “my keys” vector, the LLM can extract the user-specific information. Additionally, the LLM interprets the question as a request for location. Using a projection (dot product) of the “location” vector with the “my keys” vector results in the “restaurant” vector. This may be provided as a text result: “I last saw your keys at the restaurant” and/or an image of their keys at the restaurant.

While the foregoing example is presented in the context of an LLM-based chatbot that can assist a user based on information that has been “seen” by smart glasses, the techniques may be broadly extended to machine-initiated discovery of the user's context (e.g., websites, applications, etc.). For example, the LLM-based chatbot could be further coupled with other applications for forward-looking applications, etc. Under such a paradigm, the LLM-based chatbot might not only be able to answer where the keys were last seen, but also where a user might need their keys (or any other materials, etc.). As another such example, a user at a grocery store might be able to ask not only what groceries they need (e.g., based on a previously captured image) but also what groceries they will need in the future (e.g., based on menu planning software, etc.)

More directly, user-specific embedding vectors allow the LLM to consider contextual associations that are specific to the user, in addition to the generically-trained embedding vectors. While the foregoing discussion is presented in the context of user-specific embedding vectors, the techniques may be broadly extended to any person-specific, animal-specific, place-specific, time-specific, or other tangible/intangible object-specific embedding vector. In addition, while the foregoing discussion is presented in the context of a single user, the techniques may be broadly extended to any grouping of the foregoing. Thus, for example, a first member of a family or other social group may use a “family-specific” embedding vector or a “pet-specific” embedding vector to e.g., identify who fed the family pet last, whether medication was administered at the pet feeding, etc.

3.2 Privacy and/or Access Control Considerations

As previously alluded to, user-specific data is complicated by a variety of considerations. Even though highly granular user-specific data has limited value for the user, it can be lucrative for third parties to collect, misuse, and/or abuse. This is particularly problematic for user gaze information which can be used to infer user thoughts and/or behaviors. While privacy and/or access control restrictions are important, practical implementations must also balance user convenience. In other words, users should have the ability to quickly and conveniently control how and when user-specific data is captured, stored, used, etc.

Conceptually, many diverse pieces of information often can be combined together to provide a holistic gestalt of the user's context. For example, an image capture of what the user is looking at could be relatively innocuous on its own; however, the same information could be much more intrusive when aggregated with other bits of user context e.g., current location, patterns of purchase, and/or usage history. Conventional access control is based on enabling and/or disabling functionality; for example, a user can enable camera access, location access, etc. At most, functionality-based access control may be adjusted for different applications. Nonetheless, in many cases, this level of control does not allow the user to define what context the data is being used for, etc.

Exemplary embodiments of the present disclosure enable edge context-based access control over the edge device capture mechanism and/or resulting captured data. Framing access control within edge context allows the user to conveniently control when and how data is captured (rather than e.g., a set of Boolean functionalities that are in effect for all conditions, until changed). Furthermore, the edge device (or aggregator, intermediary, etc.) may inform the user how the captured data will be used; in one specific implementation, the access requests may be presented, and responded to, in plain language within the specific user's context. In some variants, the exemplary system may also insulate and/or enable requests from 3^{rd} parties (much like a firewall). 3^{rd} parties may request access to the edge device in order to trigger a data capture; depending on the user's specific access policies, the request may be stopped (or passed) at the intermediary service, the aggregator, and the edge device.

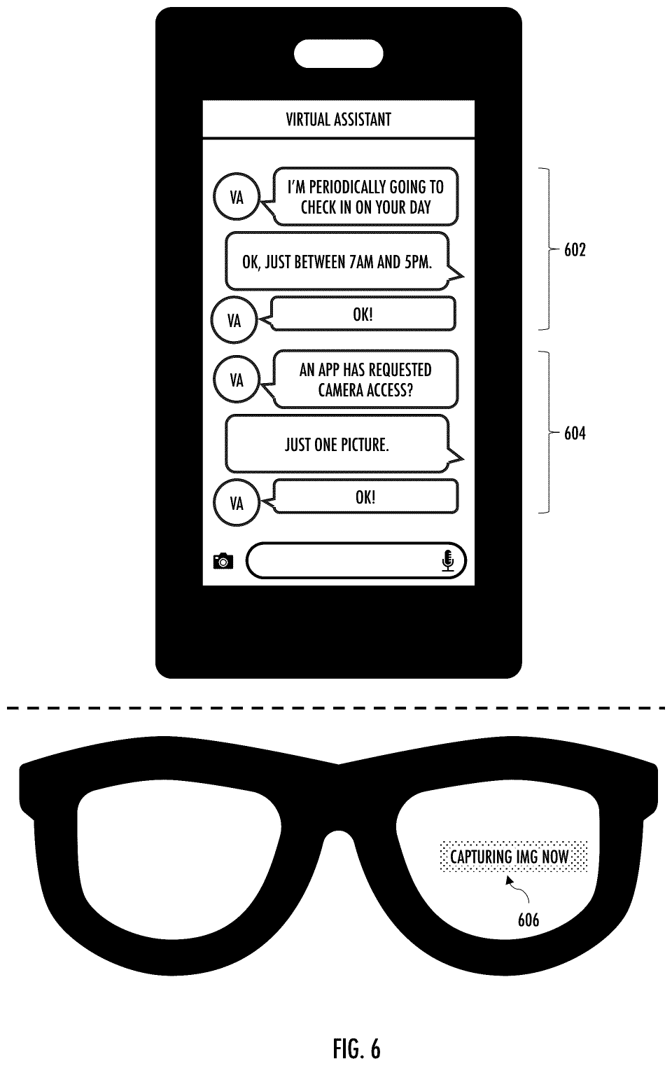

As shown in FIG. 6, an exemplary virtual assistant application may use a large language model (LLM) based “chatbot” to request permission to collect data from a pair of smart glasses (see e.g., messaging interaction 602 of FIG. 6). In the illustrated example, the user limits access to a specified duration. Other implementations might limit access according to time (daytime, nighttime), duration (next 4 hours, next 8 hours, etc.), frequency (every 1 min, 5 min, etc.), location (home, work, etc.), activity, captured data modalities (e.g., images and voice, images only, captions only, etc.), etc.

Additionally, the virtual assistant application may periodically receive requests from other devices and/or third parties that request access to the user's smart glasses (see e.g., messaging interaction 604 of FIG. 6). In some cases, the user may be notified of requested and/or ongoing captures via a heads-up display (HUD) 606, audible sound, haptic vibration, or other user interface notification.

While the foregoing example is presented in the context of an LLM-based chatbot interface, other interfaces for the virtual assistant may be substituted. Examples may include physical switches/buttons, a configuration application, AR/XR gestures, audible commands, and/or any other user interaction. For example, a user might tap a button on their smart glasses to disable image capture for a preconfigured interval (e.g., the next 30 minutes), etc. As another such example, certain users may prefer other modalities over text—this may have implications for privacy. Here, a user may prefer their interactions via generated imagery; e.g., the generative intelligence may draw images and/or provide related captioning that are subjectively informative but lack sensitive information. In other cases, the generated imagery may be similar enough to convey information, but obscured in a manner that might still ensure privacy. For example, a request to locate keys may be presented with enough detail to identify location (e.g., bedroom dresser), but with added blurring/noise, etc.

More broadly, edge context-based access control may be extended to any context-based access control systems for any inferred information at any entity of the exemplary system (e.g., cloud context-based access control, etc.). For example, an aggregator may be enabled/limited in how it will aggregate different modalities of data. Similarly, an intermediary cloud service may be enabled/limited in how it performs resource allocations and/or processing.

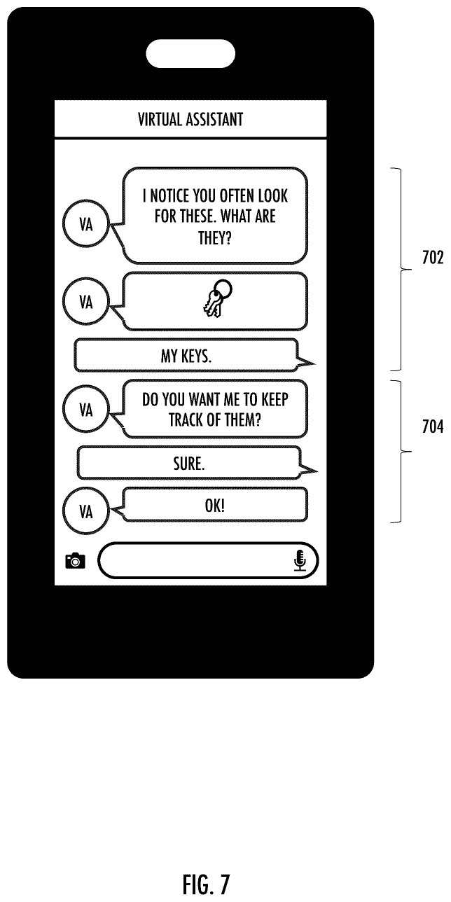

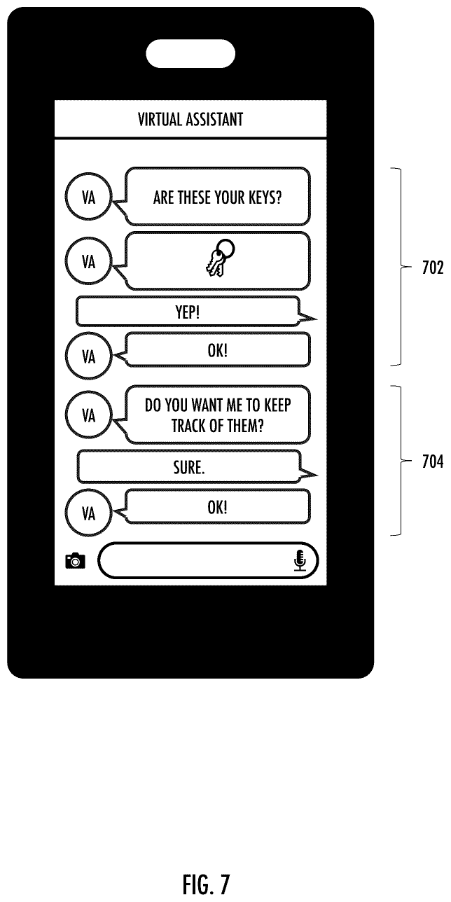

Consider the scenario of FIG. 7 where the exemplary virtual assistant software aggregates different modalities of information from different edge devices (e.g., images from smart glasses, location from smart phone, etc.). In the illustrated example, the virtual assistant identifies objects from images captured throughout the user's day, based on computer vision analysis (image-based modality). Similarly, the virtual assistant may associate location tags (location-based modality) to the computer vision tags. After repeated identifications of the same object in different locations, the virtual assistant may infer that the object has some importance to the user. The virtual assistant software uses an LLM-based chatbot to ask the user about the nature of the object (“keys”) in transaction 702 and identifies a relationship between the user and the object (“my keys”).

Once the user has verified that the identified object is a user-specific object, the virtual assistant may assign a user-specific embedding vector (“my keys”), which allows the identified object to be tracked as part of the accumulated user context. Here, the user-specific embedding vector represents information that is aggregated across multiple different modalities (image, location, etc.). The virtual assistant may then seek permission to track the user-specific object in transaction 704. The request is limited to a context-specific application (tracking a user-specific object) and is not an open-ended request to enable a device functionality (e.g., the camera, nor track location). While the edge device may capture image and location data, the accumulated user context does not need (and may be restricted from access to) the underlying image and location data-relying instead on the user-specific embedding vector. In some variants, access to the underlying edge data (captured image and/or location data) may require an additional request and/or different permissions.

As but another example, the intermediary cloud service may provide cloud context-based access control for social applications. For example, a group of friends may be looking for a restaurant; however, group-based usage scenarios are not always optimal for every user; e.g., a vegetarian and a non-vegetarian are unlikely to have overlapping “best” fits, but a less well-fit restaurant may be acceptable to both. Each user of the group may have specific user preferences and/or dietary restrictions that are important in this context. The users' virtual assistants may collaborate and share their context-specific information so that an acceptable restaurant for the entire group can be identified. However, other context-specific information might be sensitive information that can be shielded from the other virtual assistants by default (e.g., previous dining history, etc.). In some cases, the virtual assistants may suggest a proposed set of choices, which is independently checked by each virtual assistant based on its own considerations. For example, a virtual assistant for one user may reject an option due to privately held information (e.g., previous dining history).

More generally, the intermediary cloud service may enforce access control for any network resource access. In some cases, a user may expressly specify what information may be shared with the network resource (and limitations, if any). In other cases, a user may have default access control settings which can be modified, if necessary. For example, a user may ask a question that may be answered by an LLM-based chatbot; the chatbot may request more information—the requested information may be considered sensitive by default, however the user may permit the release of the information for this particular usage. Similarly, network entities may request access to a user's data; in these cases, the intermediary may shield the user's sensitive information and/or notify the user and request permission.

### 3.3 Layers for User-Specific Data

As a practical matter, data size significantly affects transfer size and/or data processing. Thus, exemplary embodiments collect and categorize user-specific data at different layers. Each layer is further associated with selected modalities of the device ecosystem. For example, a first layer may be associated with captured data from smart glasses, a second layer may be aggregate data from multiple user devices (e.g., a smart watch, smart phone, and smart glasses), a third layer may aggregate data generated across multiple user interactions over time and space. Organizing data according to different layers allows devices to selectively route and/or handle the relevant embedding vectors to service user requests (rather than continuously collecting data of unknown importance). [ono] Different functionality may be associated with different layers. For example, some user interactions may be directly handled with captured data (e.g., at the first layer); examples might include e.g., “where are my keys?”, “did I leave my stove on?”, etc. More complicated interactions might need two or more edge devices to coordinate; for example, smart glasses may capture data while a smart phone accesses the Internet (e.g., “what can I make with these ingredients?”, “send this (image) to my mother.”, etc.). Still other types of user interactions may require interpretation and/or response from generative intelligence at the third layer e.g., “who here knows this person?”, “what do we usually order here?”, etc.).

User context may be useful in a variety of applications at the edge device. In some cases, edge devices may use user context to alter their operation and/or functionality. As but one example, smart glasses may use user intent to alter the frame appearance; for example, if a person is looking at a blue object, the smart glasses frames may turn blue. As another example, a person that is looking at a product might cause the smart glasses to display a logo of the product. However, different types of context information may be important to different applications. Thus, for example, persistent and habitual behaviors may be more useful than the instantaneous user context for certain types of applications.

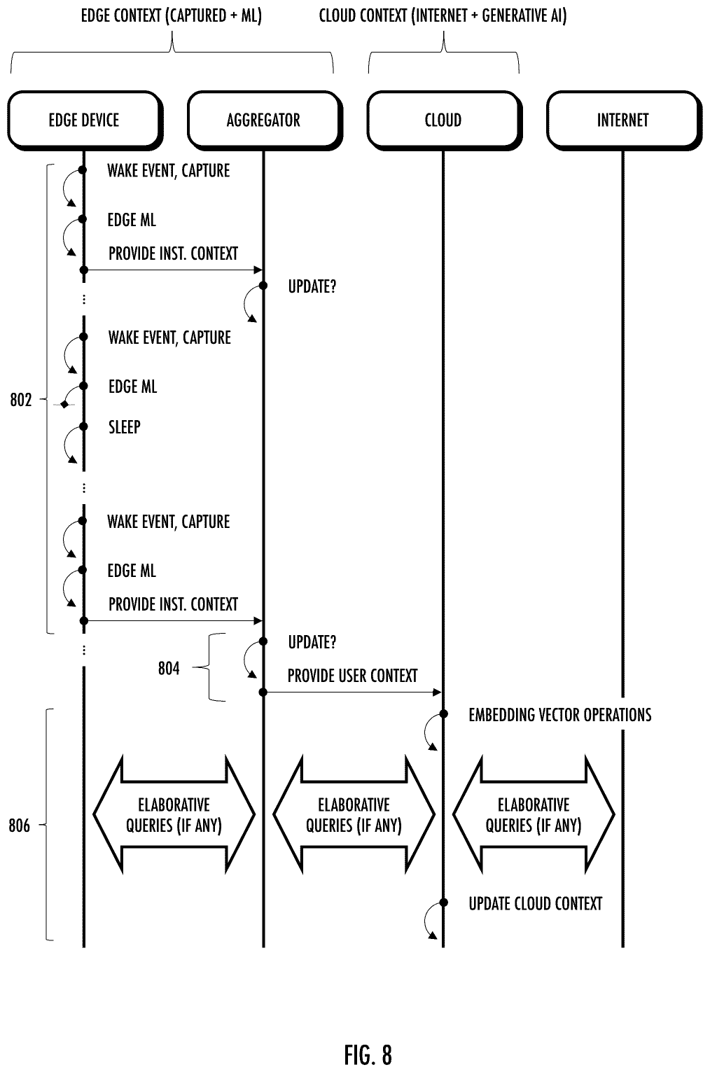

Consider the scenario depicted in FIG. 8, where an ecosystem of devices uses different layers of data to minimize unnecessary data transfers. During a first interval 802, an edge device (such as smart glasses, a smart watch, a smart phone, etc.) periodically wakes up to capture instantaneous user context information (e.g., audiovisual content, location data, etc.). The instantaneous user context information may be processed with edge device machine learning (ML) logic to determine whether the instantaneous user context information is potentially interesting.

Potentially interesting content may be identified by the edge device ML based on novelty, importance, and/or other relevant metrics. For example, the user's smart glasses may intermittently wake up and capture an image and/or audio data. If the captured data contains e.g., a new face/object, a user-specific item, voice activity, etc., then the captured data may be locally stored or provided to an aggregator device. Otherwise, the edge device returns to sleep.

The aggregator device (e.g., a smart phone, laptop, etc.) manages connectivity between the edge device and the cloud. As shown at interval 804, the aggregator device collects instantaneous user context information from one or more edge devices and determines whether (and/or when) the edge context should be used to update the accumulated user context (also referred to as the “cloud context”). The aggregator device may consider a variety of factors including e.g., time sensitivity, importance, user configuration, system resources (power, memory, bandwidth), etc.

Upon receiving edge context information, the cloud service(s) may update the accumulated user context. The cloud service(s) may perform a variety of different embedding vector functions including without limitation: addition (e.g., to create new connections between embedding vectors), subtraction (e.g., to remove connections between embedding vectors), dot products (e.g., to identify similarities between different embedding vectors). In some cases, as shown at interval 806, the cloud service(s) may additionally trigger elaborative queries to further refine the accumulated user context.

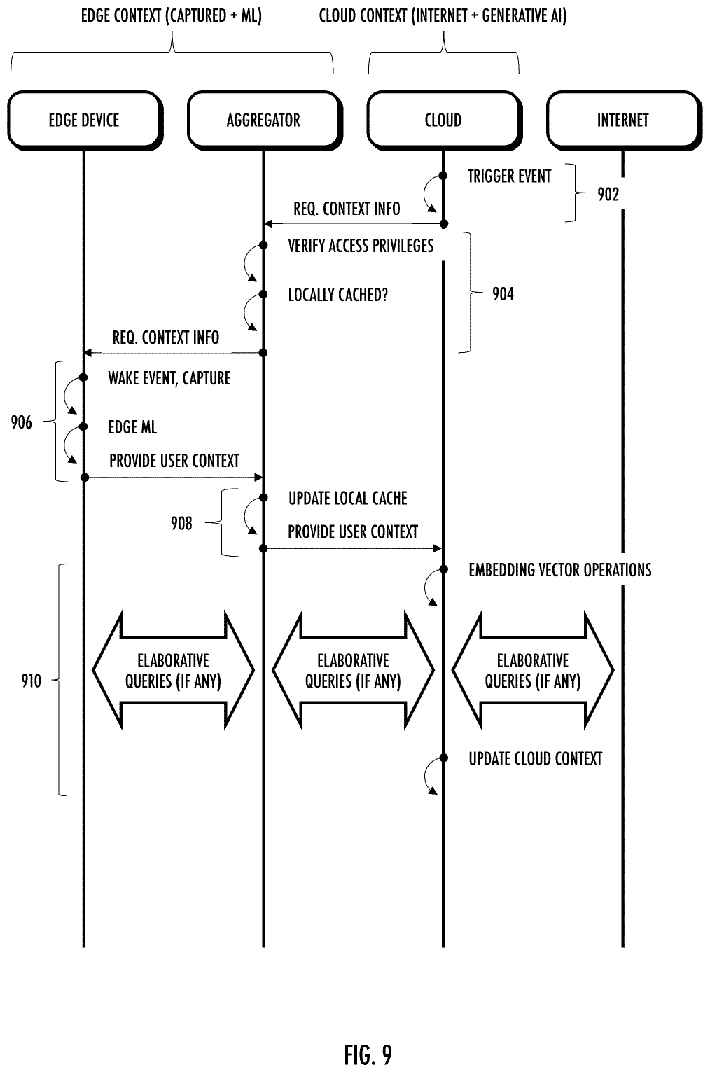

Referring now to FIG. 9, the ecosystem of devices may also use different layers of data to enable network-triggered access. Here, the cloud service(s) may request updated edge context based on a trigger event (interval 902). For example, a networked application might periodically check-in on the user, or the network application might page the user on behalf of another user, etc.

As previously noted, the aggregator device manages connectivity between the edge device and the cloud. At interval 904, the aggregator device receives a request from the cloud service(s) and verifies that the cloud service(s) has the appropriate access permissions. The aggregator device may also explicitly notify the user of the request. The aggregator device may be able to answer the request based on locally cached data; if not, then the aggregator device may request an update from the edge device.

Once awakened, the edge device captures the instantaneous user context and provides the update to the aggregator device (interval 906). The aggregator device then updates its locally cached edge context and provides the updated edge context to the cloud service(s).

The cloud service(s) may then update its accumulated user context (interval 908). In some cases, the cloud service(s) may additionally trigger elaborative queries to further refine the accumulated user context (interval 910). In some cases, the cloud service(s) may also access the broader internet to further refine and/or elaborate on user queries.

Furthermore, while foregoing discussion is presented in the context of a specific organization scheme, the techniques described throughout may be broadly extended to any hierarchical organization of data. This may include for example, multi-user applications. For example, a professor in a classroom may obtain real-time feedback on what their students are looking at (and presumably understanding) for the duration and location of class. However, the professor would not have access to students tracking data that are either not in class and/or outside of class time. In some variants, the user-specific information may include identifying information; alternatively, user-specific information may be anonymized.

### 3.4 Emulating Session Persistence for Generative Intelligence

As previously alluded to, conventional implementations of LLMs (used in generative intelligence chatbots such as CHATGPT™) can establish and preserve conversational context during a session, however the session data is destroyed once closed. Session-pruning is necessary for any practical implementation of LLM chatbots to minimize ongoing processing cost.

In contrast, exemplary embodiments of the present disclosure initialize the LLM to a “personalization state” with user-specific context information prior to operation. Rather than requiring the LLM to infer the user-specific context information as part of an ongoing session, the techniques described herein allow a new session to emulate a continuation of a previous session.

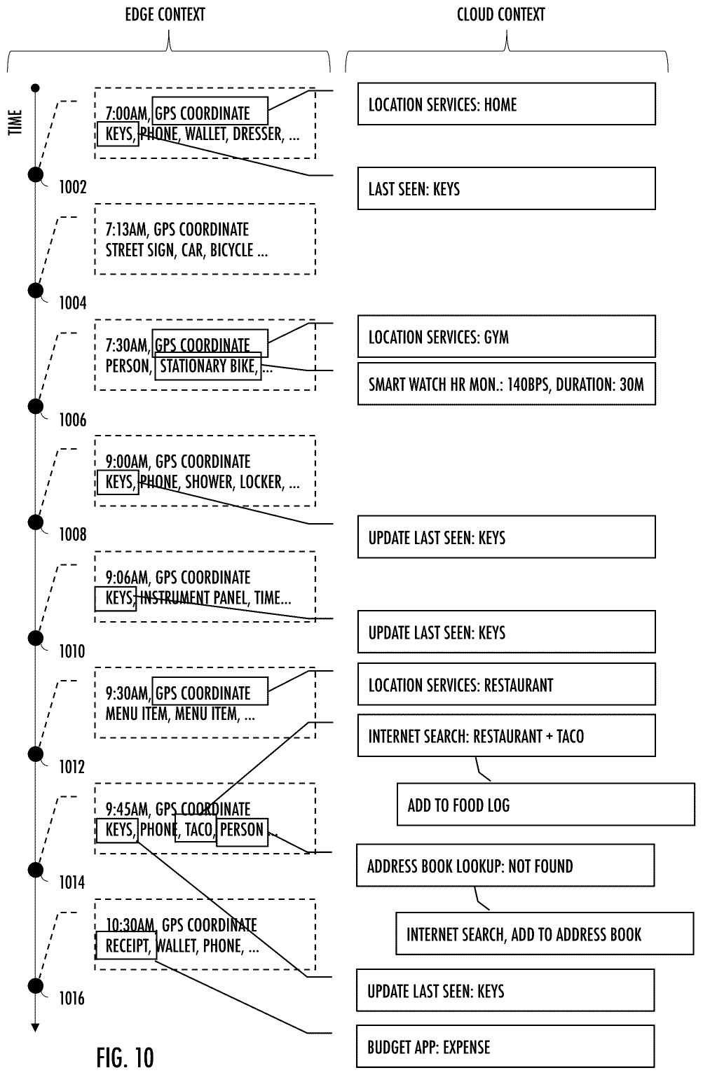

FIG. 10 presents one exemplary scenario where an LLM-based chatbot emulates session persistence for user-specific information. The user wakes up and dons their smart glasses and/or other edge devices. The edge devices then begin to capture and store instantaneous user context information throughout their day.

At time 1002, the smart glasses may record time (7:00 AM) and location (GPS coordinates, landmark identification, relative location, or other descriptor (“kitchen”), etc.). Additionally, the smart glasses may capture and identify user-specific objects: e.g., keys (“my keys”), phone (“my phone”), and wallet (“my wallet”). A smart phone (or other aggregator device) provides the information to cloud services. The cloud services provide storage, internet access, 3^{rd} party applications, and an LLM-based chatbot service with emulated session persistence. Here, the cloud services update the relevant cloud context with relevant edge context; for example, in this case, the cloud context includes the user's location (home) and identifies the last known location of the user's keys.

While the foregoing example is presented in the context of a user's possessions, the techniques may be broadly extended to any association (possessory or otherwise.) For example, a user might associate “spouse's keys” to their spouse's keys, or “our pet” (joint association) to a family pet. Certain types of objects may be associated with an unknown placeholder; for example, a new person's face might be treated with a unique identifier “UNK_0001”, “UNK_0001's keys”, etc.—this allows for potentially important associations to be captured and identified on-the-fly even with incomplete information. Later, the user may enter or encounter new information which allows the placeholder information to be completed and/or post-annotated (e.g., “Te-Won”, “Te-Won's keys”, etc.).

A short time later (time 1004), the user gets into their car and starts traveling. Instantaneous user context is captured and stored, but the edge ML does not identify any interesting data. The smart glasses return to sleep without updating the cloud context.

At time 1006, the user arrives at a destination. Instantaneous user context is captured and stored, and the edge ML of the smart glasses identifies a stationary bike. The user's smart watch (another edge device) also captures heart rate and duration information. The aggregator device obtains both pieces of edge context and sends the combined edge context to the cloud services.

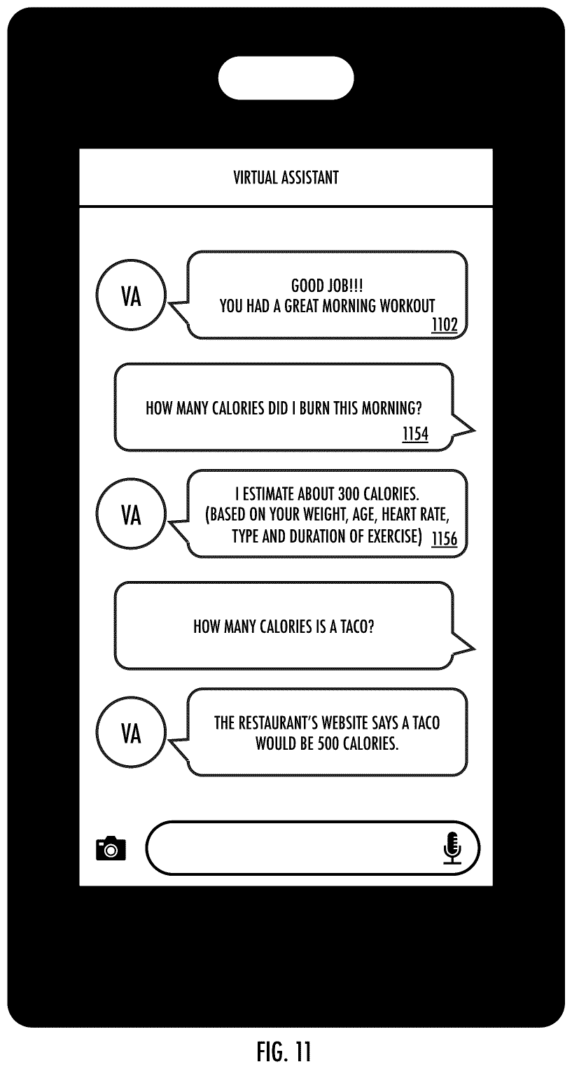

In this case, the user has a 3^{rd} party fitness application that has subscribed to user health events. The cloud services trigger a fitness event based on the edge context (stationary bike caption, HR, and duration data). As shown in FIG. 11, the fitness application sends the user an encouraging message 1102 via an application programming interface (API) call to a virtual assistant hosted by the cloud services.

The user continues with their morning routine; instantaneous user context is captured and stored, but the edge ML does not identify any interesting data at time 1008 or time 1010.

At time 1012, the user meets a friend for breakfast. Instantaneous user context is captured and stored. The user has recently exercised but does not know how many calories they burned. Out of curiosity, the user sends a question 1154 to their virtual assistant.

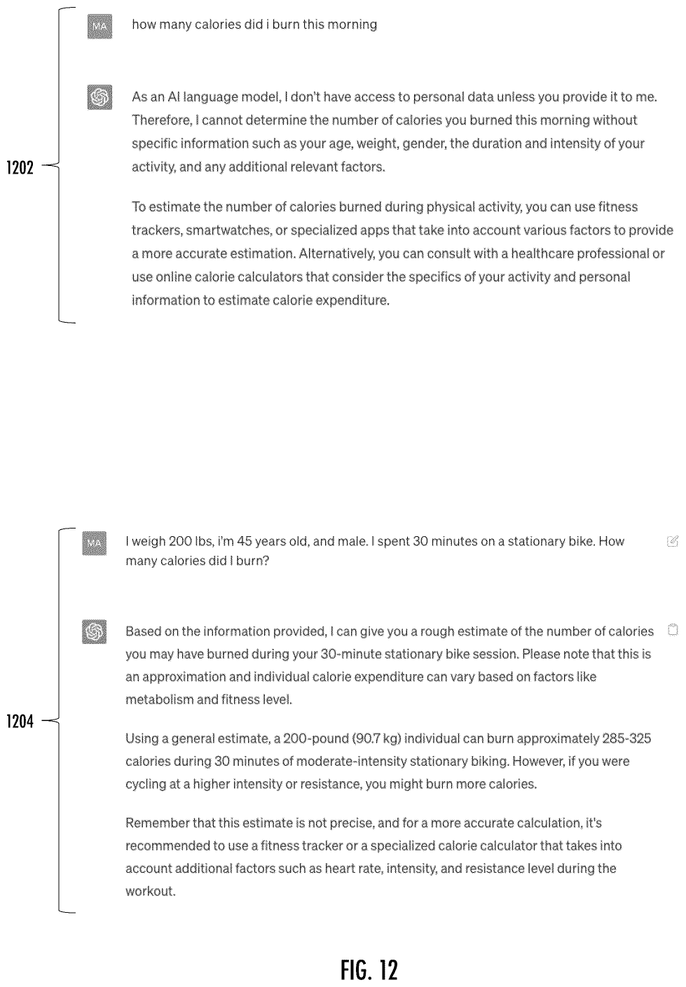

As previously noted, the virtual assistant is hosted by the cloud services. The cloud services identify the user request as a freeform question which can be handled by an LLM-based chatbot. The cloud services start an LLM-based chatbot session; the chatbot could be incorporated as part of the cloud services or wholly separate as a 3^{rd} party application accessible via API. Notably, a generically-trained chatbot without personal information would typically return a statement such as (see response 1202 of FIG. 12):
As an AI language model, I don't have access to personal data unless you provide it to me. Therefore, I cannot determine the number of calories you burned this morning without specific information such as your age, weight, gender, the duration and intensity of your activity, and any additional relevant factors . . . .

However, if the generically-trained chatbot is provided user-specific data via a pre-prompt, the chatbot can return an accurate result (see response 1204 of FIG. 12):
Based on the information provided, I can give you a rough estimate of the number of calories you may have burned during your 30-minute stationary bike session . . .
Using a general estimate, a 200-pound (90.7 kg) individual can burn approximately 285-325 calories during 30 minutes of moderate-intensity stationary biking. However, if you were cycling at a higher intensity or resistance, you might burn more calories . . .

More directly, the LLM-based chatbot is not “functionally limited”, but rather “data limited”. The foregoing interactions show that the LLM-based chatbot can identify the additional user-specific data that is necessary to complete its task (e.g., age, weight, gender, the duration and intensity of your activity, etc.). When provided with the additional user-specific data, the LLM-based chatbot provides the appropriate response. Thus, virtual assistant responses for user-specific queries can be enabled by initializing an LLM chatbot to a “personalization state” using the user-specific context information. Various exemplary embodiments provide the user-specific edge context (e.g., pre-prompts, initialization data, user-specific embedding vectors and/or other edge specific data) to an LLM-based chatbot. In some variants, the LLM-based chatbot may also receive the earlier messages as a pre-prompt.

User-specific context information may be stored in a user profile that is accessible by the virtual assistant. The virtual assistant may use data stored within the user profile to provide personalized answers from the LLM-based chatbot. The user profile may store information about user preferences that may be gathered through continuous data collection and communication with users, details about people around the user, biographical and personal information of the user (e.g., age, birthday, gender, occupation, height, etc.), user contact information (e.g., phone number(s) and email addresses, etc.), social media profiles, and information about the user's belongings (e.g., labels, locations, etc.).

Referring back to FIG. 11, the virtual assistant hosted by the cloud services sends the user a response message 1156 with the response from the LLM-based chatbot.

Looking at the menu, the user may follow up with a question to their virtual assistant about the number of calories of a food item (“how many calories is a taco?”). The cloud services identify the user request as a freeform question which can be handled by an LLM-based chatbot. The cloud services may continue the LLM-based chatbot session and ask the user question to the LLM-based chatbot. The cloud services may provide user-specific context information including location information (GPS coordinates or information about the restaurant) allowing the LLM-based chatbot to reply. The reply may include a contextually relevant response, based on the location information of the user, with the calories of the food item on the restaurant's menu rather than a non-context specific response for the calories of the food item generally.

At time 1014, another person arrives at the restaurant and sits across from the user. Instantaneous user context is captured and stored, and the edge ML of the smart glasses identifies a person, keys, and a taco. The aggregator device sends the edge context to the cloud services. Cloud services may add the taco to a food log of the user. Cloud services may also identify the person and perform a look up of the person in the address book of the user. Upon not finding an entry for the person, the cloud services may perform an internet search to determine the contact information of the person. Cloud services may retrieve the contact information of the person and add a new contact to an address book of the user.

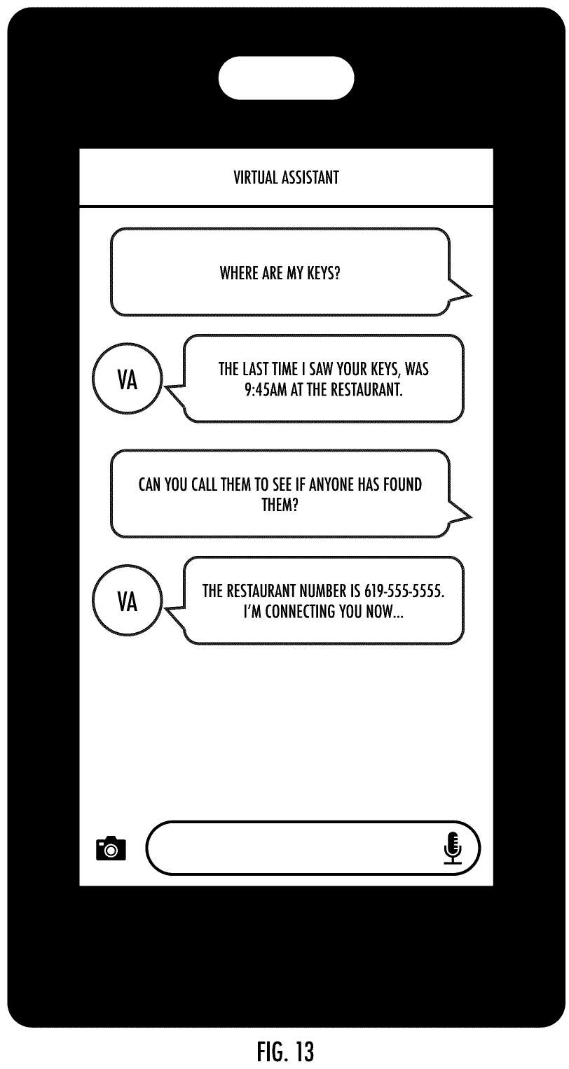

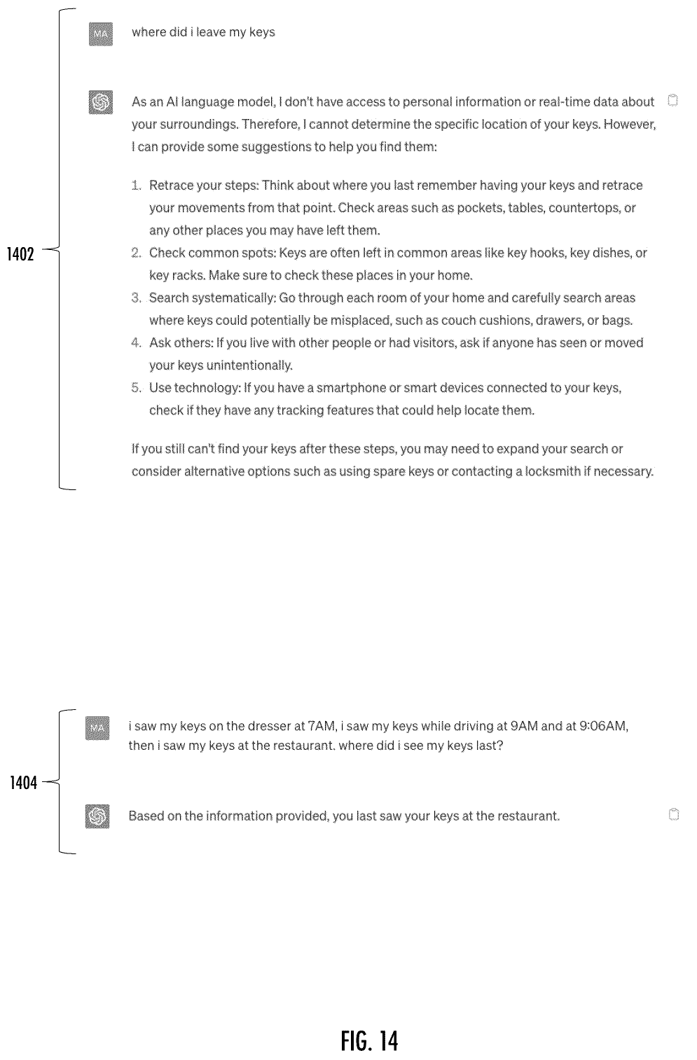

At time 1016, the user forgot where they put their keys; the user asks the LLM-based chatbot where their keys are (see FIG. 13). Here, the cloud services identify the user request as another freeform question which can be handled by an LLM-based chatbot, but which is unrelated to the previous conversation. The cloud services start a new LLM-based chatbot session (shown in FIG. 13). Again, while a generically-trained chatbot cannot answer this question (see response 1402 of FIG. 14), providing the generically-trained chatbot with previous user-specific context gathered at time 1002, time 1008, time 1010, and time 1014 would enable a usable response (see response 1404 of FIG. 14).

As demonstrated above, initializing new sessions to address questions “as-needed” provides the illusion of persistence from the user's previous conversation history and cloud context without a persistent session. As a further benefit, minimizing the amount of initialization data and session state information also allows for much smaller, less complex exchanges. This can greatly reduce data transfer bandwidth and LLM processing costs.

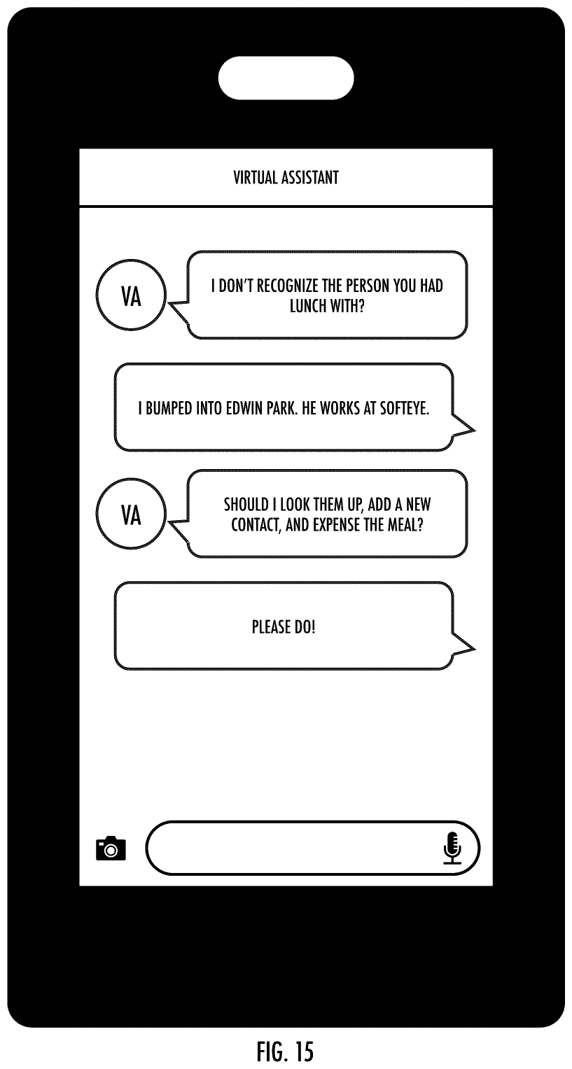

While the foregoing examples are presented in the context of a user-initiated exchange, FIG. 15 illustrates a device-initiated exchange. Here, the cloud service periodically updates the user-specific cloud context with newly collected edge context. During this process, the cloud service may review interesting new information identified by the edge ML logic; for example, the cloud service may review e.g., new faces/objects, user-specific items, voice activity, etc. Certain types of information may require additional elaborative queries. For example, in the illustrated embodiment, the cloud services identify a new face, and prompt the user regarding the next actions (e.g., adding a contact, and expensing a meal).

### 4 System Architecture

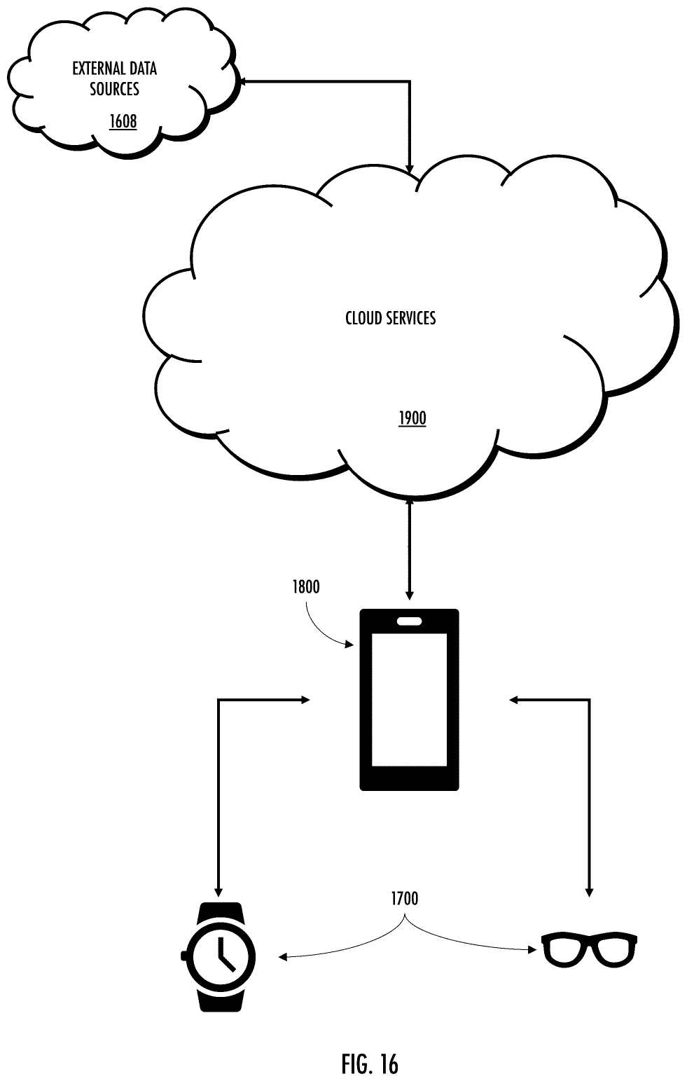

FIG. 16 is a logical block diagram of one exemplary system architecture. As shown, the network infrastructure includes: edge device(s) 1700, aggregator device(s) 1800, a cloud service(s) 1900, and external data source(s) 1608.

The following examples are discussed in the context of edge devices that capture images and/or audio input from the user's environment, an aggregator device that aggregates edge capture data from multiple devices for cloud-based processing, and a cloud-based service that manages resource allocation and/or foundation model processing. More generally, however, artisans of ordinary skill in the related arts will readily appreciate that the functionalities described herein may be combined, divided, hybridized, and/or augmented within different entities. For example, a smart phone may have both edge functionality (e.g., capturing location information via GPS, etc.) as well as aggregator functionality (e.g., combining data streams from a connected smart glasses and smart watch). In another such example, a sufficiently capable smart phone may implement foundation model processing locally (rather than at a cloud service). Here, the smart phone may caption the instantaneous user context (or perform other forms of pre-processing) and/or aggregate the instantaneous user context for use with a local small LLM. The small LLM may then process the text data to identify what the user's attention is focused on. As yet another example, multiple distinct edge devices (e.g., smart glasses, smart phone, etc.) may communicate directly with a cloud service, which performs both aggregation as well as resource allocation, etc.

While the following discussion is presented in the context of a smart phone aggregator device that maintains a Bluetooth personal area network (PAN) with edge devices (smart glasses and smart watch), other types of devices and/or networks may be substituted with equal success. For example, a laptop, smart glasses, a smart watch, or smart car may provide network connectivity via hotspot, etc. Similarly, while present discussion is described in the context of Bluetooth, other networking technologies may be substituted with equal success. For instance, a smart phone may use Bluetooth/Wi-Fi ad hoc networking to connect to multiple devices of the user's mobile area network (e.g., smart glasses, smart watch, smart car, etc.).

### 4.1 Edge Capture

Edge devices refer to devices that are at the “edge” of the system-functionally, edge devices are used to capture the user's interactions and data about the environment and/or other instantaneous user context.

As a practical matter, edge devices may have a broad range of capability. For example, simple devices may capture data with sensors and pass the raw data to more sophisticated devices in the ecosystem. More sophisticated implementations may pre-process the instantaneous user context to detect user interest. Complex implementations may also aggregate data from other devices, implement localized processing, and/or even perform foundation model-type processing (e.g., large language models, large multimodal models, etc.). More broadly, any device that collects instantaneous user context may provide “edge device” functionality. For example, a smart phone may passively collect location information as part of its background tasks. Similarly, heart rate data may be collected from a smart watch, etc.

In some embodiments, edge devices may enforce localized control over data capture. For example, a user may enable or disable the cameras, microphones, and/or other sensors of their smart glasses for certain times of the day, certain activities, and/or certain locations. In some variants, the user may have the ability to provide default access settings and/or manually override default access settings.

While the following discussions are primarily discussed in the context of user-triggered data captures (which the user is aware of), edge devices may also receive and/or service capture requests from other entities (which the user may not be aware of). For example, an aggregator device may request a data capture either for its own operations, or on behalf of another entity (e.g., an LLM may need additional information about the user's context in order to provide a response). In some cases, the user may request/require notification for such accesses; other forms of access control may also be used (e.g., rule-based, etc.).

### 4.1.1 Implementation and Design Considerations

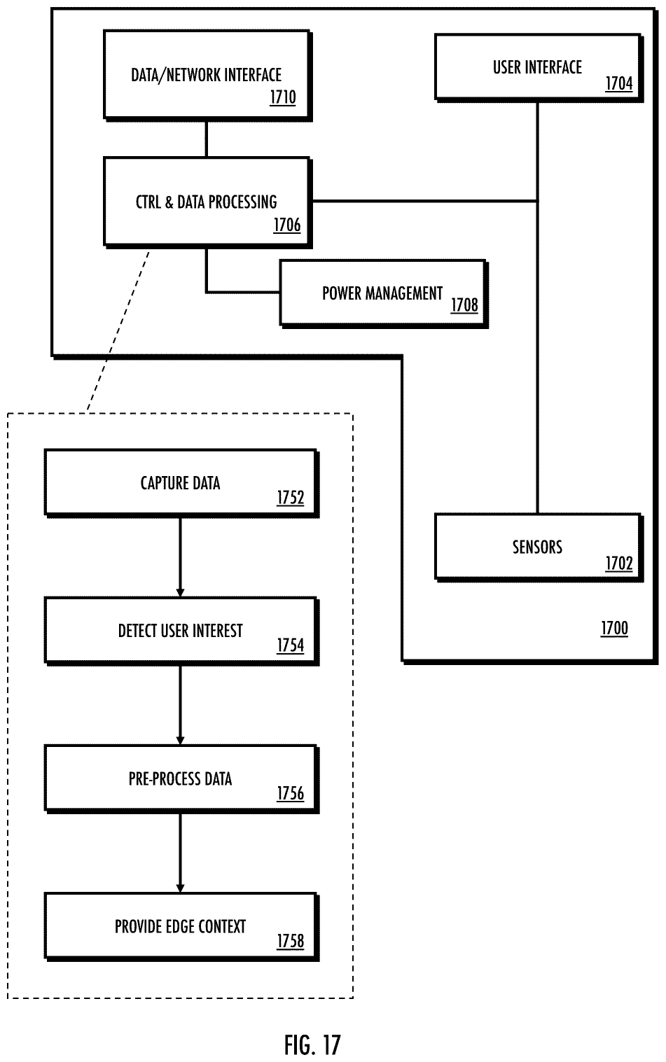

FIG. 17 is a logical block diagram of the exemplary edge device 1700. The edge device 1700 includes: a sensor subsystem 1702, a user interface subsystem 1704, control and data processing logic 1706, a power management subsystem 1708, and a data/network interface 1710.

The sensor subsystem 1702 captures data from the environment. The user interface subsystem 1704 monitors the user for user interactions and renders data for user consumption. The control and data processing logic 1706 obtains data generated by the user, other devices, and/or captured from the environment, to perform calculations and/or data manipulations. The resulting data may be stored, rendered to the user, transmitted to another party, or otherwise used by the edge device to carry out its tasks. The power management subsystem 1708 supplies and controls power for the edge device components. The data/network logic 1710 converts data for transmission to another device via removeable storage media or some other transmission medium. In some cases, the edge device may additionally include a physical frame that attaches the edge device to the user, freeing either one or both hands (hands-free operation).

The various logical subsystems described herein may be combined, divided, hybridized, and/or augmented within various physical components of a device. As but one such example, an eye-tracking camera and forward-facing camera may be implemented as separate, or combined, physical assemblies. As another example, power management may be centralized within a single component or distributed among many different components; similarly, data processing logic may occur in multiple components of the edge device. More generally, the logical block diagram illustrates the various functional components of the edge device, which may be physically implemented in a variety of different manners.

Referring first to the sensor subsystem, a “sensor” refers to any electrical and/or mechanical structure that measures, and records, parameters of the physical environment as analog or digital data. Most consumer electronics devices incorporate multiple different modalities of sensor data; for example, visual data may be captured as images and/or video, audible data may be captured as audio waveforms (or their frequency representations), inertial measurements may be captured as quaternions, Euler angles, or other coordinate-based representations.

While the present disclosure is described in the context of audio data, visual data, and/or IMU data, artisans of ordinary skill in the related arts will readily appreciate that the raw data, metadata, and/or any derived data may be substituted with equal success. For example, an image may be provided along with metadata about the image (e.g., facial coordinates, object coordinates, depth maps, etc.). Post-processing may also yield derived data from raw image data; for example, a neural network may process an image and derive one or more activations.

In one exemplary embodiment, the sensor subsystem may include: one or more camera module(s), an audio module, an accelerometer/gyroscope/magnetometer (also referred to as an inertial measurement unit (IMU)), a display module (not shown), and/or Global Positioning System (GPS) system (not shown). The following sections provide detailed descriptions of the individual components of the sensor subsystem.

A camera lens bends (distorts) light to focus on the camera sensor. The camera lens may focus, refract, and/or magnify light. It is made of transparent material such as glass or plastic and has at least one curved surface. When light passes through a camera lens, it is bent or refracted in a specific way, which can alter the direction, size, and/or clarity of the image that is formed.

A camera sensor senses light (luminance) via photoelectric sensors (e.g., photosites). A color filter array (CFA) filters light of a particular color; the CFA provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image. Notably, most imaging formats are defined for the human visual spectrum; however, machine vision may use other variants of light. For example, a computer vision camera might operate on direct raw data from the image sensor with a RCCC (Red Clear Clear Clear) color filter array that provides a higher light intensity than the RGB color filter array used in media application cameras.

A camera sensor may be read using the readout logic. Conventional readout logic uses row enables and column reads to provide readouts in a sequential row-by-row manner. Historically, display devices were unaware of image capture but could optimize for their own raster-graphics scan line style of operation. Conventional data formats assign one dimension to be “rows” and another dimension to be “columns”; the row and column nomenclature is used by other components and/or devices to access data. Most (if not all) devices assume that scan lines are rows that run horizontally (left to right), and columns that run vertically (top to bottom), consistent with conventional raster-scan style operation.

A “digital image” is a two-dimensional array of pixels (or binned pixels). Virtually all imaging technologies are descended from (and inherit the assumptions of) raster-graphics displays which displayed images line-by-line. The aspect ratio of a digital image may be any number of pixels wide and high. However, images are generally assumed to be longer than they are tall (the rows are larger than columns).

During operation, the edge device may make use of multiple camera systems to assess user interactions and the physical environment. For example, smart glasses may have one or more outward-facing cameras to capture the user's environment. Multiple forward-facing cameras can be used to capture different fields-of-view and/or ranges. Cameras with a non-fixed/“zoom” lens may also change its focal length to capture multiple fields of view. For example, a medium range camera might have a horizontal field-of-view (FOV) of 70°-120° whereas long range cameras may use a FOV of 35°, or less, and have multiple aperture settings. In some cases, a “wide” FOV camera (so-called fisheye lenses provide between 120° and 195°) may be used to capture periphery information along two transverse axes. In some implementations, one or more anamorphic cameras may be used to capture a wide FOV in a first axis (major axis) and a medium range FOV in a second axis (minor axis). In addition, the smart glasses may have one or more inward-facing cameras to capture the user's interactions. Multiple cameras can be used to capture different views of the eyes for eye-tracking. In some implementations, one or more anamorphic cameras may be used to track eye movement. Other implementations may use normal FOV cameras that are stitched together or otherwise processed jointly.

More generally, however, any camera lens or set of camera lenses may be substituted with equal success for any of the foregoing tasks; including e.g., narrow field-of-view (10° to 90°) and/or stitched variants (e.g., 360° panoramas). While the foregoing techniques are described in the context of perceptible light, the techniques may be applied to other electromagnetic (EM) radiation capture and focus apparatus including without limitation: infrared, ultraviolet, and/or X-ray, etc.

The camera module(s) may include on-board image signal processing and/or neural network processing. On-board processing may be implemented within the same silicon or on a stacked silicon die (within the same package/module). Silicon and stacked variants reduce power consumption relative to discrete component alternatives that must be connected via external wiring, etc. Processing functionality is discussed further below.

The camera module(s) incorporates on-board logic to generate image analysis statistics and/or perform limited image analysis. As but one such example, the camera sensor may generate integral image data structures at varying scales. In some cases, the integral images may have reduced precision (e.g., only 8-bits, 12-bits, 16-bits, of precision). Notably, even at reduced precision, integral images may be used to calculate the sum of values in a patch of an image. This may enable lightweight computer vision algorithms that perform detection and/or recognition of objects, faces, text, etc.

More generally, a variety of applications may leverage preliminary image analysis statistics. For example, computer-assisted searches and/or other recognition algorithms, etc. are discussed in greater detail within U.S. patent application Ser. No. 18/185,362 filed Mar. 16, 2023, and entitled “APPARATUS AND METHODS FOR AUGMENTING VISION WITH REGION-OF-INTEREST BASED PROCESSING”, U.S. patent application Ser. No. 18/185,364 filed Mar. 16, 2023, and entitled “APPARATUS AND METHODS FOR AUGMENTING VISION WITH REGION-OF-INTEREST BASED PROCESSING”, and U.S. patent application Ser. No. 18/185,366 filed Mar. 16, 2023, and entitled “APPARATUS AND METHODS FOR AUGMENTING VISION WITH REGION-OF-INTEREST BASED PROCESSING”, previously incorporated by reference above.

Various embodiments of the present disclosure may additionally leverage improvements to scalable camera sensors and/or asymmetric camera lenses, discussed in greater detail within U.S. patent application Ser. No. 18/316,181 filed May 11, 2023, and entitled “METHODS AND APPARATUS FOR SCALABLE PROCESSING”, U.S. patent application Ser. No. 18/316,214 filed May 11, 2023, and entitled “METHODS AND APPARATUS FOR SCALABLE PROCESSING”, U.S. patent application Ser. No. 18/316,206 filed May 11, 2023, and entitled “METHODS AND APPARATUS FOR SCALABLE PROCESSING”, U.S. patent application Ser. No. 18/316,203 filed May 11, 2023, and entitled “APPLICATIONS FOR ANAMORPHIC LENSES”, U.S. patent application Ser. No. 18/316,218 filed May 11, 2023, and entitled “APPLICATIONS FOR ANAMORPHIC LENSES”, U.S. patent application Ser. No. 18/316,221 filed May 11, 2023, and entitled “APPLICATIONS FOR ANAMORPHIC LENSES”, U.S. patent application Ser. No. 18/316,225 filed May 11, 2023, and entitled “APPLICATIONS FOR ANAMORPHIC LENSES”, previously incorporated by reference above.

An audio module typically incorporates a microphone, speaker, and an audio codec. The microphone senses acoustic vibrations and converts the vibrations to an electrical signal (via a transducer, condenser, etc.). The electrical signal is provided to the audio codec, which samples the electrical signal and converts the time domain waveform to its frequency domain representation. Typically, additional filtering and noise reduction may be performed to compensate for microphone characteristics. The resulting audio waveform may be compressed for delivery via any number of audio data formats. To generate audible sound, the audio codec obtains audio data and decodes the data into an electrical signal. The electrical signal can be amplified and used to drive the speaker to generate acoustic waves.

Commodity audio codecs generally fall into speech codecs and full spectrum codecs. Full spectrum codecs use the modified discrete cosine transform (mDCT) and/or mel-frequency cepstral coefficients (MFCC) to represent the full audible spectrum. Speech codecs reduce coding complexity by leveraging the characteristics of the human auditory/speech system to mimic voice communications. Speech codecs often make significant trade-offs to preserve intelligibility, pleasantness, and/or data transmission considerations (robustness, latency, bandwidth, etc.).

An audio module may have any number of microphones and/or speakers. For example, multiple speakers may be used to generate stereo sound and multiple microphones may be used to capture stereo sound. More broadly, any number of individual microphones and/or speakers can be used to constructively and/or destructively combine acoustic waves (also referred to as beamforming). The audio module may include on-board audio processing and/or neural network processing to assist with voice analysis and synthesis.

The inertial measurement unit (IMU) may include one or more accelerometers, gyroscopes, and/or magnetometers. Typically, an accelerometer uses a damped mass and spring assembly to measure proper acceleration (i.e., acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both head direction and speed).

More generally, however, any scheme for detecting user velocity (direction and speed) may be substituted with equal success for any of the foregoing tasks. Other useful information may include pedometer and/or compass measurements. While the foregoing techniques are described in the context of an inertial measurement unit (IMU) that provides quaternion vectors, artisans of ordinary skill in the related arts will readily appreciate that raw data (acceleration, rotation, magnetic field) and any of their derivatives may be substituted with equal success.

Global Positioning System (GPS) is a satellite-based radio navigation system that allows a user device to triangulate its location anywhere in the world. Each GPS satellite carries very stable atomic clocks that are synchronized with one another and with ground clocks. Any drift from time maintained on the ground is corrected daily. In the same manner, the satellite locations are known with great precision. The satellites continuously broadcast their current position. During operation, GPS receivers attempt to demodulate GPS satellite broadcasts. Since the speed of radio waves is constant and independent of the satellite speed, the time delay between when the satellite transmits a signal and the receiver receives it is proportional to the distance from the satellite to the receiver. Once received, a GPS receiver can triangulate its own four-dimensional position in spacetime based on data received from multiple GPS satellites. At a minimum, four satellites must be in view of the receiver for it to compute four unknown quantities (three position coordinates and the deviation of its own clock from satellite time). In so-called “assisted GPS” implementations, ephemeris data may be downloaded from cellular networks to reduce processing complexity (e.g., the receiver can reduce its search window). The IMU may include on-board telemetry processing and/or neural network processing to assist with telemetry analysis and synthesis.

Referring now to the user interface subsystem, the “user interface” refers to the physical and logical components of the edge device that interact with the human user. A “physical” user interface refers to electrical and/or mechanical devices that the user physically interacts with. An “augmented reality” user interface refers to a user interface that incorporates an artificial environment that has been overlaid on the user's physical environment. A “virtual reality” user interface refers to a user interface that is entirely constrained within a “virtualized” artificial environment. An “extended reality” user interface refers to any user interface that lies in the spectrum from physical user interfaces to virtual user interfaces.

The user interface subsystem may encompass the visual, audio, and tactile elements of the device that enable a user to interact with it. In addition to physical user interface devices that use physical buttons, switches, and/or sliders to register explicit user input, the user interface subsystem may also incorporate various components of the sensor subsystem to sense user interactions. For example, the user interface may include: a display module to present information, eye-tracking camera sensor(s) to monitor gaze fixation, hand-tracking camera sensor(s) to monitor for hand gestures, a speaker to provide audible information, and a microphone to capture voice commands, etc.

The display module is an output device for presentation of information in a visual form. Different display configurations may internalize or externalize the display components within the lens. For example, some implementations embed optics or waveguides within the lens and externalize the display as a nearby projector or micro-LEDs. As another such example, some implementations project images into the eyes.

The display module may be incorporated within the device as a display that is overlaps the user's visual field. Examples of such implementations may include so-called “heads up displays” (HUDs) that are integrated within the lenses, or projection/reflection type displays that use the lens components as a display area. Existing integrated display sizes are typically limited to the lens form factor, and thus resolutions may be smaller than handheld devices e.g., 640×320, 1280×640, 1980×1280, etc. For comparison, handheld device resolutions that exceed 2560×1280 are not unusual for smart phones, and tablets can often provide 4K UHD (3840×2160) or better. In some embodiments, the display module may be external to the glasses and remotely managed by the device (e.g., screen casting). For example, smart glasses can encode a video stream that is sent to a user's smart phone or tablet for display.

The display module may be used where smart glasses present and provide interaction with text, pictures, and/or AR/XR objects. For example, the AR/XR object may be a virtual keyboard and a virtual mouse. During such operation, the user may invoke a command (e.g., a hand gesture) that causes the smart glasses to present the virtual keyboard for typing by the user. The virtual keyboard is provided by presenting images on the smart glasses such that the user may type without contact to a physical object. One of ordinary skill in the art will appreciate that the virtual keyboard (and/or mouse) may be displayed as an overlay on a physical object, such as a desk, such that the user is technically touching a real-world object. However, input is measured by tracking user movements relative to the overlay, previous gesture position(s), etc. rather than receiving a signal from the touched object (e.g., as a conventional keyboard would).

The user interface subsystem may incorporate an “eye-tracking” camera to monitor for gaze fixation (a user interaction event) by tracking saccadic or microsaccadic eye movements. Eye-tracking embodiments may greatly simplify camera operation since the eye-tracking data is primarily captured for standby operation (discussed below). In addition, the smart glasses may incorporate “hand-tracking” or gesture-based inputs. Gesture-based inputs and user interactions are more broadly described within e.g., U.S. patent application Ser. No. 18/061,203 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/061,226 filed Dec. 2, 2022, and entitled “SYSTEMS, APPARATUS, AND METHODS FOR GESTURE-BASED AUGMENTED REALITY, EXTENDED REALITY”, and U.S. patent application Ser. No. 18/061,257 filed Dec. 2, 2022, and entitled “SYSTEMS, APPARATUS, AND METHODS FOR GESTURE-BASED AUGMENTED REALITY, EXTENDED REALITY”, previously incorporated by reference in their entireties.

While the present discussion describes eye-tracking and hand-tracking cameras, the techniques are broadly applicable to any outward-facing and inward-facing cameras. As used herein, the term “outward-facing” refers to cameras that capture the surroundings of a user and/or the user's relation relative to the surroundings. For example, a rear outward-facing camera could be used to capture the surroundings behind the user. Such configurations may be useful for gaming applications and/or simultaneous localization and mapping (SLAM-based) applications. As used herein, the term “inward-facing” refers to cameras that capture the user e.g., to infer user interactions, etc.

The user interface subsystem may incorporate microphones to collect the user's vocal instructions as well as the environmental sounds. As previously noted above, the audio module may include on-board audio processing and/or neural network processing to assist with voice analysis and synthesis.

The user interface subsystem may also incorporate speakers to reproduce audio waveforms. In some cases, the speakers may incorporate noise reduction technologies and/or active noise cancelling to cancel out external sounds, creating a quieter listening environment for the user. This may be particularly useful for sensory augmentation in noisy environments, etc.

Functionally, the data/network interface subsystem enables communication between devices. For example, the edge device may communicate with an aggregator device. In some cases, the edge device may also need to access remote data (accessed via an intermediary network). For example, a user may want to look up a menu from a QR code (which visually embeds a network URL) or store a captured picture to their social network, social network profile, etc. In some cases, the user may want to store data to removable media. These transactions may be handled by a data interface and/or a network interface.

The network interface may include both wired interfaces (e.g., Ethernet and USB) and/or wireless interfaces (e.g., cellular, local area network (LAN), personal area network (PAN)) to a communication network. As used herein, a “communication network” refers to an arrangement of logical nodes that enables data communication between endpoints (an endpoint is also a logical node). Each node of the communication network may be addressable by other nodes; typically, a unit of data (a data packet) may be traverse across multiple nodes in “hops” (a segment between two nodes). For example, smart glasses may directly connect, or indirectly tether to another device with access to, the Internet. “Tethering” also known as a “mobile hotspot” allows devices to share an internet connection with other devices. For example, a smart phone may use a second network interface to connect to the broader Internet (e.g., 5G/6G cellular); the smart phone may provide a mobile hotspot for a smart glasses device over a personal area network (PAN) interface (e.g., Bluetooth/Wi-Fi), etc.

The data interface may include one or more removeable media. Removeable media refers to a memory that may be attached/removed from the edge device. In some cases, the data interface may map (“mount”) the removable media to the edge device's internal memory resources to expand its operational memory.

The control and data subsystem controls the operation of a device and stores and processes data. Logically, the control and data subsystem may be subdivided into a “control path” and a “data path.” The data path is responsible for performing arithmetic and logic operations on data. The data path generally includes registers, arithmetic and logic unit (ALU), and other components that are needed to manipulate data. The data path also includes the memory and input/output (I/O) devices that are used to store and retrieve data. In contrast, the control path controls the flow of instructions and data through the subsystem. The control path usually includes a control unit, that manages a processing state machine (e.g., a program counter which keeps track of the current instruction being executed, instruction register which holds the current instruction being executed, etc.). During operation, the control path generates the signals that manipulate data path operation. The data path performs the necessary operations on the data, and the control path moves on to the next instruction, etc.

The control and data processing logic may include one or more of: a central processing unit (CPU), an image signal processor (ISP), one or more neural network processors (NPUs), and their corresponding non-transitory computer-readable media that store program instructions and/or data. In one exemplary embodiment, the control and data subsystem includes processing units that execute instructions stored in a non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

Different processor architectures attempt to optimize their designs for their most likely usages. More specialized logic can often result in much higher performance (e.g., by avoiding unnecessary operations, memory accesses, and/or conditional branching). For example, a general-purpose CPU may be primarily used to control device operation and/or perform tasks of arbitrary complexity/best-effort. CPU operations may include, without limitation: operating system (OS) functionality (power management, UX), memory management, gesture-specific tasks, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks, and must account for branch disruption and/or arbitrary memory access.

In contrast, the image signal processor (ISP) performs many of the same tasks repeatedly over a well-defined data structure. Specifically, the ISP maps captured camera sensor data to a color space. ISP operations often include, without limitation: demosaicing, color correction, white balance, and/or autoexposure. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. ISP designs only need to keep up with the camera sensor output to stay within the real-time budget; thus, ISPs more often benefit from larger register/data structures and do not need parallelization.

In some cases, the device may include one or more neural network processors (NPUs). Unlike the Turing-based processor architectures, machine learning algorithms learn a task that is not explicitly described with instructions. In other words, machine learning algorithms seek to create inferences from patterns in data using e.g., statistical models and/or analysis. The inferences may then be used to formulate predicted outputs that can be compared to actual output to generate feedback. Each iteration of inference and feedback is used to improve the underlying statistical models. Since the task is accomplished through dynamic coefficient weighting rather than explicit instructions, machine learning algorithms can change their behavior over time to e.g., improve performance, change tasks, etc.

Conceptually, neural network processing uses a collection of small nodes to loosely model the biological behavior of neurons. Each node receives inputs, and generates output, based on a neuron model (usually a rectified linear unit (ReLU), or similar). The nodes are connected to one another at “edges”. Each node and edge are assigned a weight. Each processor node of a neural network combines its inputs according to a transfer function to generate the outputs. The set of weights can be configured to amplify or dampen the constituent components of its input data. The input-weight products are summed and then the sum is passed through a node's activation function, to determine the size and magnitude of the output data. “Activated” neurons (processor nodes) generate output “activations”. The activation may be fed to another node or result in an action on the environment. Coefficients may be iteratively updated with feedback to amplify inputs that are beneficial or dampen inputs that are not.

The behavior of the neural network may be modified during an iterative training process by adjusting the node/edge weights to reduce an error gradient. The computational complexity of neural network processing is a function of the number of nodes in the network. Neural networks may be sized (and/or trained) for a variety of different considerations. For example, increasing the number of nodes may improve performance and/or robustness noise rejection whereas reducing the number of nodes may reduce power consumption and/or improve latency.

Typically, machine learning algorithms are “trained” until their predicted outputs match the desired output (to within a threshold similarity). Training is broadly categorized into “offline” training and “online” training. Offline training models are trained once using a static library, whereas online training models are continuously trained on “live” data. Offline training allows for reliable training according to known data and is suitable for well-characterized behaviors. Furthermore, offline training on a single data set can be performed much faster and at a fixed power budget/training time, compared to online training via live data. However, online training may be necessary for applications that must change based on live data and/or where the training data is only partially-characterized/uncharacterized. Many implementations combine offline and online training to e.g., provide accurate initial performance that adjusts to system-specific considerations over time.

In some implementations, the NPU may be incorporated within a sensor (e.g., a camera sensor) to process data captured by the sensor. By coupling an NPU closely (on-die) with the sensor, the processing may be performed with lower power demand. In one aspect, the sensor processor may be designed as customized hardware that is dedicated to processing the data necessary to enable interpretation of relatively simple user interaction(s) to enable more elaborate gestures. In some cases, the sensor processor may be coupled to a memory that is configured to provide storage for the data captured and processed by the sensor. The sensor processing memory may be implemented as SRAM, MRAM, registers, or a combination thereof.

Other processor subsystem implementations may multiply, combine, further subdivide, augment, and/or subsume the foregoing functionalities within these or other processing elements. For example, multiple ISPs may be used to service multiple camera sensors. Similarly, neural network functionality may be subsumed with either CPU or ISP operation via software emulation.

In one embodiment, the control and data processing subsystem may be used to store data locally at the device. In one exemplary embodiment, data may be stored as non-transitory symbols (e.g., bits read from non-transitory computer-readable mediums). In one specific implementation, a memory subsystem including non-transitory computer-readable medium is physically realized as one or more physical memory chips (e.g., NAND/NOR flash) that are logically separated into memory data structures. The memory subsystem may be bifurcated into program code and/or program data. In some variants, program code and/or program data may be further organized for dedicated and/or collaborative use.

In some embodiments, the program code may be statically stored within the device as firmware. In other embodiments, the program code may be dynamically stored (and changeable) via software updates. In some such variants, software may be subsequently updated by external parties and/or the user, based on various access permissions and procedures.

### 4.1.2 User Content Capture and Interest Detection

In the illustrated embodiment, the non-transitory computer-readable medium includes a routine that captures instantaneous user context and/or pre-processes the instantaneous user context to detect user interest. When executed by the control and data subsystem, the first routine causes the edge device to: capture data from the sensor subsystem, pre-process the captured data to generate instantaneous user context, and provide the stream of instantaneous user context to another device (e.g., an aggregator device, a cloud service, etc.). In some variants, the pre-processing may additionally include detecting user interest. The following discussion explores these steps in more detail.

At step 1752, the edge device captures data via the sensor subsystem. While the following discussion is discussed in the context of one edge device, most usage scenarios may have multiple edge devices. For example, a mobile ecosystem might include smart glasses, a smart phone, and a smart watch, all of which are actively capturing information about a user and their environment. While the present disclosure is primarily discussed in the context of audio/visual data, location, and motion data, virtually any sensed data may be substituted with equal success. Data captured by the sensor subsystem may represent specific physical properties and changes in the user and/or environment.

A capture refers to the process of collecting data or information at a specific point in time using a designated device or system. Captures can be initiated in various ways depending on the requirements of the task or system. They can be triggered automatically by specific events or conditions, such as a motion sensor activating when movement is detected or a camera capturing an image when a button is pressed, gesture detected, voice command, etc. Captures can also be scheduled to occur at regular intervals (e.g., throughout a user's daily routine). Additionally, captures can be externally triggered by another entity (e.g., an aggregator device, cloud service, etc.). For example, an aggregator may need additional edge context to supplement its existing data, similarly a cloud service may request edge context to understand a user's intention.

In some cases, captures may incorporate metadata to provide information about the captured data. For example, metadata may include type, format, mode of capture, time of capture, etc. Metadata may be particularly important for e.g., aligning, comparing, and/or processing different types of data. For example, sample rates and/or timestamps may be useful to align data captured on different time scales; resolution, image size, etc. may be useful to scale images captured on different sensors, etc.

In one embodiment, captures may be restricted based on access control restrictions. Within the context of an edge device, access control refers to the mechanisms and policies that regulate when, where, who and/or what can interact with the sensor, including triggering capture, reading data, configuring its settings, and/or any other sensor-based functionality. For example, access control may be based on permissions and authentication protocols to ensure that only authorized individuals, devices, or systems can access the sensor's functions and data.

In some variants, access control may be based on a defined set of rules and/or conditions. For example, the user may identify times, locations, and/or applications that may trigger data capture. In some examples, the user may additionally identify default rules to grant/deny, as well as the ability to manually override the default rules based on application-specific considerations. In some cases, manual override may require e.g., biometric safeguards, password protection, two-factor authentication, etc.

At step 1754, the edge device may additionally detect user interest. In some embodiments, the user interest may be based on a gaze point, verbal instruction, or other user interaction. More broadly, captured data may be substantial, yet not all of it may be of interest. Focusing and/or filtering captured data may be useful to reduce processing burden, memory footprint, power consumption, etc. For example, a user may only be focused on a region-of-interest (within a larger image capture), providing the entire captured image may be unnecessary and/or inefficient. Similarly, a user may only be focused on data captured at a specific moment (or temporal range), data outside of the selected window may be unrelated and/or add noise.

In some embodiments, the user interest may be explicitly signaled by the user. For example, the user may provide visual, audible, and/or gestural cues that can be used to interpret their interest. In other embodiments, user interest may be inferred from the captured data based on e.g., generalized rules, training, and/or previous usage. In still other embodiments, user interest may be received via an out-of-band mechanism. For example, an edge device may be notified of user interest from an aggregator device and/or intermediary device.

At step 1756, the edge device pre-processes the captured data to generate instantaneous user context. Pre-processing may prepare captured data for downstream analysis by cleaning and conversion to a suitable format. Cleaning generally includes tasks such as removing noise and outliers, handling missing values, normalizing or scaling data. For example, in image processing, pre-processing might involve resizing images, adjusting brightness, and filtering out noise to enhance quality. Conversion refers to any translation of data from e.g., one domain to another domain. For example, time-domain inputs may be converted to frequency-domain spectral coefficients via FFT, DCT, etc. Other examples of conversions may translate between modalities, e.g., image-to-text, speech-to-text, etc.

As previously noted, “instantaneous user context” refers to user context that is specific to a specific instant of time. Here, the edge device captures data that represents the user and their environment at the moment of capture. Instantaneous user context may be (and usually is) different than other aspects of user context which may be accumulated and/or persist over spatial and/or temporal usage.

As previously alluded to, the user context may include user generated prompts (e.g., verbal commands, gaze point, gestures, and/or other forms of user interactions). In such variants, the user context may be pre-processed with an input specializer to provide more context for downstream processing. For example, an LLM input specializer may be used to augment user context with additional input for an LLM. Functionally, an LLM input specializer augments the user's prompt in view of captured data and/or personalization data (“persona”). In one specific implementation, the LLM input specializer maintains a map of different prompt augmentations (pre-prompts, mid-prompts, post-prompts) for different types of questions.

In one specific implementation, image-to-text and/or speech-to-text processes the input data to generate labels. Mapping logic maps the labels various classification areas. For example, a person looking at a menu (and/or asking about a menu item) would be mapped to the general category of food, etc. Here, the LLM input specializer may provide prompt augmentation based on a set of previously stored food-related prompt augmentations.

While the foregoing example uses machine generated labels for prompt augmentation, other types of augmentation may be based on key words or key phrases. For example, the LLM input specializer may have a list of specific words or phrases that are commonly used (generic or user-specific) together with a variety of different locations, activities, etc. Such keywords may include e.g.: “who”, “what”, “where”, “when”, “how”, etc.; key phrases might include e.g., “what can I do . . . ”, “what is . . . ”, “how much is . . . ”, “where did I . . . ”, etc. In other words, if speech-to-text translation of the user's prompt includes “what is . . . ” then a first set of pre-prompts are mapped, if the prompt includes “how much is . . . ” then a different set of pre-prompts may be mapped.

More generally, the term “map” and its linguistic derivatives refer to any logic that associates labels (e.g., inferred from user intent) to a set of elements (here, predefined prompt augmentations). While the foregoing examples are presented in the context of simple mappings, the concepts are broadly applicable to any association (including one-to-one, one-to-many, many-to-one, many-to-many, etc.). Additionally, while the foregoing example is presented in the context of a one-to-one look-up, more complex variants may use e.g., a reduced-complexity LLM or other text analysis logic to provide more complex associations.

In some cases, the LLM input specializer may also consider LLM-specific factors such as e.g., availability, latency, cost, etc. when augmenting the prompt. While the exemplary LLM input specializer may not directly launch the query (this may be performed by a query constructor described in greater detail below), the LLM input specializer may use LLM-specific information to change the amount of information and/or type of information provided to a query constructor. Furthermore, some variants may also allow the LLM input specializer to recommend a destination LLM to the query constructor. For example, an LLM input specializer may recognize the environment as a work environment and recommend a work-specific LLM (or otherwise topically-specific LLM). As another example, an LLM input specializer may recognize that the user appears to be referring to their own property (e.g., “where are my keys?”, etc.) and may infer that the prompt should be directed to the user-specific database. Still other user prompts may be qualitatively or quantitatively assessed for complexity; more complex prompts may require more sophisticated LLMs, simpler prompts may be more quickly (and inexpensively handled) with simple LLMs.

While the present discussion is described in the context of a single LLM input specializer, various implementations may use multiple LLM input specializers to further subdivide prompt augmentation. As but one such example, the smart glasses may include a first LLM input specializer that augments prompts based on its captured data, whereas the smart phone may have a second LLM input specializer that augments the prompt in view of persona data (described below). In some embodiments, multiple LLM input specializers may be parallelized and/or serialized. Parallelized processing may be important for reducing latency of multiple independent processing tasks; for example, where a user prompt may touch on multiple distinct topical areas or specialties (these data are unrelated and separate). Serialized processing may be useful for dependent tasks (e.g., topically, sequentially, and/or conditionally related). For example, a user may ask for suitable restaurants nearby (e.g., place/time information is dependent on personalization information). As another example, a user may ask for information about a specific hole on a golf course (e.g., both generalized information as well as user-specific notes from previous play (if any)).

As another important note, words/tokens and sensed data have significant differences in size. A large amount of sensed data may be condensed into only a few tokens; thus, input specialization that occurs at the smart glasses can greatly reduce the amount of data that needs to be sent to the smart phone. This directly corresponds to reduced processing, encoding, memory and power consumption on both devices, as well as any downstream processing. While the exemplary embodiments are discussed in the context of “words” and “text”, the concepts may be broadly extended to any user device that can capture data from its environment (e.g., images, sounds, symbols, gestures and other user interactions, etc.) and convert the data into tokens or other data structures natively used within a machine learning foundation model.

Furthermore, input specialization may be useful in a variety of other contexts. In other words, while LLM input specializers are designed to augment prompts with additional information in a natural language format, the mapping/association techniques described above can be readily adapted to other types of models (e.g., large multi-modal models (LMMs), foundation models, and/or other forms of generative intelligence). For example, a website input specializer may be used to map speech-to-text, images, and/or image-to-text over into generic website specific inputs and/or navigation. Similarly, a social network input specializer may be used to map speech-to-text, images, and/or image-to-text over to social network-based interactions.

At step 1758, the edge device provides the instantaneous user context to another device. In some embodiments, user interest may also be provided.

In one embodiment, the edge device provides the instantaneous user context in real-time (or near real-time) as it is captured. In other embodiments, the edge device may provide the instantaneous user context at best-effort. In still other embodiments, the edge device may capture and store the instantaneous user context (along with timestamp information, if necessary) and provide the data in bulk, or offline.

Instantaneous user context may be provided to an aggregator, cloud service, or other device. In some embodiments, instantaneous user context is “pushed” by the edge device. In other embodiments, instantaneous user context may be “pulled” by the other device. In yet other embodiments, the transfer may be coordinated according to e.g., scheduling and/or handshake transfer protocols.

### 4.2 Aggregation

Functionally, the aggregator device aggregates user context from one or more sources (e.g., instantaneous user context (location, images, audio, etc.), accumulated user context, and/or user interest, etc.) to enable multi-modal attention for interactions between the user and other network entities. In order to do so, the aggregator device may process user context to identify attention. For example, a smartphone may run a small LLM (or similar generative intelligence logic) to encode and/or decode input (the voice commands, image, etc.) in combination with computer-vision analysis to assess attention.

Notably, conventional LLMs use a single modality (text) and assume a single user for chatbot-like functionality. In contrast, the exemplary embodiments described throughout aggregate information from multiple different modalities of data. For example, a user may use verbal commands (asking: “summarize the Wikipedia article for this.”) in relation to visual information (a gaze point that identifies an object, “this”) when interacting with multiple different network resources (e.g., a text-based LLM and a conventional webpage “Wikipedia”, etc.).

As used herein, the term “attention” refers to the inferred importance of tokens from their usage in relation to other tokens. Tokens are not limited to inputs; e.g., output tokens are also fed back, such that that transformer can attend to them as well. As previously noted, LLM transformer models assign contextual information to tokens in order to calculate scores that reflect the importance of the token relative to the other tokens. Importantly, the contextual information is dynamically inferred, and is not merely a defined weight/score for the token in isolation. Conceptually, LLMs assess both the actual meaning of words as well as their importance in a sentence, relative to the other words of the sentence. More generally, however, any mechanism that performs a dynamic assessment of contextual information, relative to other contextual information, may be considered an attention model.

In some embodiments, the aggregator may provide an additional layer of access control over the user's edge devices and/or other personal data. For example, certain network entities (e.g., a LLM) may request supplemental user context to provide better results; other embodiments may allow network entities to request user context based on scheduling and/or other trigger events. These requests may be granted, denied, and/or routed via the aggregator device. Conceptually, this may be particularly useful where combinations of different modalities of data and/or accumulated data may have more significance than isolated data points. For example, a user surfing the internet on their phone may have two separate devices (smart glasses and smart phone) which are each anonymous in isolation, yet when combined may be used by a 3^{rd} party to identify the user's identity and other sensitive information.

Furthermore, the aggregator device may also manage a user profile associated with the user and select portions of instantaneous user context to accumulate (or discard) to create accumulated user context. The user profile and accumulated user context are used to augment interactions between the user and external data sources (e.g., large language models (LLMs) as well as the broader internet). The aggregator device also manages ongoing conversation state, which may be distinct from the session state of the LLM.

### 4.2.1 Implementation and Design Considerations

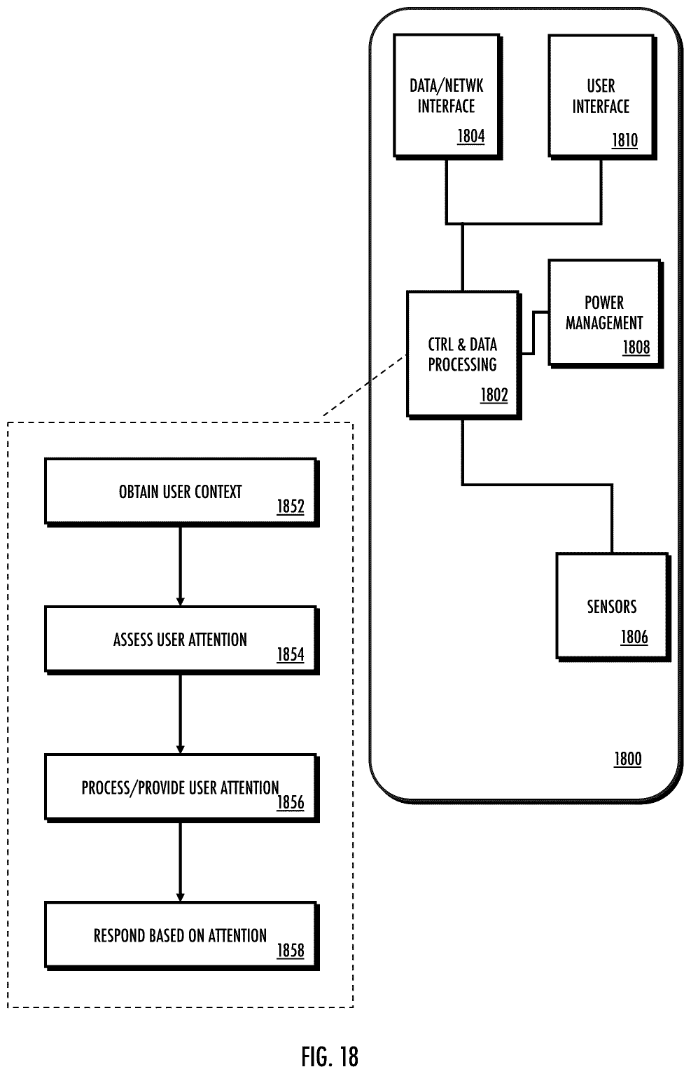

FIG. 18 is a logical block diagram of the exemplary aggregator device. The aggregator device includes: a control and data processing logic 1802 and a data/network interface 1804. The control and data processing logic 1802 obtains data generated by the user, other devices, and/or captured from the environment, to perform calculations and/or data manipulations. The data/network logic 1804 converts data for transmission to another device via removeable storage media or some other transmission medium.

Many implementations may also include a power management subsystem 1806, a sensor subsystem 1808, a user interface subsystem 1810, and/or other peripherals. For example, a smart phone implementation may include its own cameras, microphones, touchscreen, batteries, etc. More generally, the aggregator device has many similarities in operation and implementation to the edge device which are not further discussed below; the following discussion provides a discussion of the internal operations, design considerations, and/or alternatives, that are specific to aggregator device operation.

Within the context of the aggregator device, the data/network interface subsystem enables communication between devices but may have additional functionality to support its aggregation functionality. For example, the aggregator device may have multiple network interfaces with different capabilities. Here, the different wireless technologies may have different capabilities in terms of bandwidth, power consumption, range, data rates (e.g., latency, throughput), error correction, etc. In one specific implementation, the aggregator device may communicate with one or more edge devices via a first network interface (e.g., a personal area network (PAN)) and the cloud service via a second network interface (e.g., a wireless local area network (WLAN)).

As a brief aside, Bluetooth is a widely used wireless protocol that is best suited for short-range communication, and data transfer between mobile devices. Bluetooth is typically used at low data transfer rates (below 2 Mbps), and often found on devices that require low power consumption. Bluetooth networks are typically small, point-to-point networks (e.g., typically <7 devices). In contrast, Wi-Fi may be configured with larger ranges (>100 m), significantly faster data rates (9.6 Gbps), and/or much larger network topologies. Wi-Fi consumes much more power and is generally used for high-bandwidth applications, etc.

Both Bluetooth and Wi-Fi use the ISM bands which are susceptible to unknown interferers; cellular connectivity often uses dedicated frequency resources (expensive), which provides significantly better performance at much lower power. Cellular modems are able to provide high throughput over very large distances (>¼ mi).

In one embodiment, low power network interfaces may enable a “wake-up” notification. A wake-up notification for a communication device is a signal or alert that prompts the device to transition from a low-power or sleep mode to an active state. This notification is typically used in scenarios where the device needs to conserve energy when not in use but remain responsive to incoming communications or events.

The process of a wake-up notification involves the device periodically checking for any incoming signals or messages, such as network packets or signals from other devices, while in a low-power state. When a wake-up notification is received, it triggers the device to “wake up” or transition to a fully operational state, allowing it to process the incoming data, respond to commands, or initiate actions as needed. For example, the aggregator device may receive a paging notification from the cloud service that requires information from a sleeping edge device. As another such example, an edge device that is monitoring for user interest may need to wake up the aggregator device.

As previously noted, the control and data processing logic controls the operation of a device and stores and processes data. Since the aggregator device may obtain and/or combine data from multiple sources (both edge devices and cloud services), the aggregator device may be appropriately scaled in size and/or complexity. For example, the aggregator device may have multi-core processors and/or high-level operating systems that implement multiple layers of real-time, near-real-time and/or best-effort task scheduling.

4.2.2 Attention from Multi-Modal User Content

In one exemplary embodiment, the control and data processing logic includes a non-transitory computer-readable medium that includes a routine that causes the aggregator device to: obtain user context (instantaneous user context, accumulated user context, and/or user interest), encode and/or decode the user context to assess attention, and access network resources based on the attention. In some variants, the attention may be used to interact with foundation models (e.g., large language models (LLMs) and/or other foundation models) and/or other network entities. In other variants, the attention may be used to store accumulated user context for later usage. The following discussion explores these steps in more detail.

At step 1852, the aggregator device obtains user context. In one embodiment, the aggregator device is in communication with one or more edge devices to obtain instantaneous user context and/or user interest. The aggregator device may also be in communication with one or more cloud services accumulated user context and/or persona data.

In some topologies, the aggregator device may communicate with edge devices and/or the cloud services via the same network technology. In other topologies, the aggregator may communicate with edge devices and/or cloud services via different network technologies. Examples of network topologies may include e.g., Bluetooth (and other personal area networks (PANs)), Wi-Fi (and other local area networks (LANs)), cellular communications and/or satellite communications.

Different communication protocols may provide various degrees of efficiency and/or reliability. For example, most communication protocols specify a format and structure of the data being transmitted, including protocols for encoding, compression, and error detection/correction mechanisms. The communication protocol may also specify procedures for establishing and terminating communication sessions, such as handshaking protocols, connection setup, and teardown procedures. The communication protocol may also include provisions for flow control and congestion management to regulate the rate of data transmission and prevent network congestion. In some variants, the communication protocol may also specify encryption, authentication, and data integrity checks, etc. to protect sensitive information from unauthorized access or tampering during transmission. As but one such example, a Bluetooth link between and edge device and an aggregator may specify time slot, error handling, enumeration/sleep/wake procedures, and/or cryptographic key exchanges, etc.

Application Programming Interface (API) based communications are commonly used to integrate and interact between different entities, allowing them to leverage each other's functionalities and share data in a controlled and standardized manner. This may be particularly beneficial for mixed networks operation (e.g., aggregators may communicate with different edge devices and/or cloud services). Typically, API-based communications use a request/response protocol. During operation, a requesting system sends an API request, which includes specific parameters or instructions outlining the desired action or data retrieval. The receiving system processes the request based on the specified parameters and executes the corresponding actions (e.g., retrieving data from a database, performing calculations, or generating a response). Once the request is processed, the API sends a response back to the requesting system, containing the requested data or an acknowledgment of the completed action. As but one such example, a Wi-Fi link between and aggregator device and a cloud service may use an API-based protocol to transfer data.

As previously alluded to, any number of different signaling mechanisms may be used to obtain user context. User context may be “pushed” to the aggregator and/or “pulled” from another device. User context may be real-time, near real-time, and/or best-effort. Data may be transferred as-needed, on a scheduled basis, etc. For example, edge devices may push instantaneous user context to the aggregator according to real-time schedules, whereas the aggregator may pull accumulated user context from cloud services only as-needed.

While the aggregator typically obtains user context from other devices, it may also generate user context as well. In some cases, the aggregator device may capture data (e.g., a smart phone may obtain location data via GPS, etc.). In some cases, the aggregator device may accumulate data based on e.g., collected user context and/or other processing (e.g., offline stitching processes, etc.). In still other cases, the aggregator device may generate user context from its own aggregation processing, discussed below.

At step 1854 and step 1856, the aggregator device transforms (encodes and/or decodes) the user context to assess attention, and then process/provide access to network resources based on the attention. The aggregator may include “control path” logic that directs and coordinates the operations of the pipelined system. The control path generates the control signaling that determines the sequence of operations performed by the pipeline. The aggregator may also include “data path” logic responsible for manipulation and processing of data within the system. The data path performs tasks such as encoding/decoding to high dimensional space, high dimensional space operations, etc.

In some usage scenarios, user context may include a user generated prompt; e.g., the user may ask a question or issue a verbal instruction, etc. In other embodiments, the edge devices may have been monitoring the user, or another network entity may have requested (and been granted) access to the user context. Regardless of situation, the aggregator determines which portions of user context (possibly gathered across different modalities and/or sources) should be “attended” to. In other words, the aggregator device needs to identify which pieces of user context require attention.

As previously noted, transformers are a type of neural network architecture that “transforms” or changes an input sequence into an output sequence. They do this by learning context and tracking relationships between sequence components. In the context of a transformer model, “attention” refers to a mechanism that allows the model to focus on different parts of the input sequence when making predictions. The attention mechanism allows the model to weigh the importance of different words in the input sequence when generating an output sequence. A single-attention head computes attention scores between all pairs of words in the input sequence, determining how much each word should contribute to the representation of other words. Multi-headed attention captures different aspects of the input sequence simultaneously. Each attention head learns a different attention pattern, allowing the model to capture a more diverse range of relationships within the input sequence.

Within the context of the present disclosure, the aggregator device combines data from multiple data sources into an input sequence that can be processed within a transformer model. In one specific implementation, the input sequence is based on information gathered across different modalities of data. In addition to instantaneous user context, which is provided from edge devices, the aggregator may also retrieve accumulated user context based on previous user interactions, and/or user persona data (data that is specific to the user, but not derived through interactions). While the described implementations are presented in the context of a large language models (LLMs) transformer, the concepts could be readily adapted to large multi-modal models (LMMs) and/or other fundamental models.

In one embodiment, user context is converted into a common modality. For example, an LLM uses text as its common modality, thus other modalities may be converted to text. For example, images may be pre-processed with image-to-text, verbal input may be pre-processed with speech-to-text, and audio may be pre-processed with sound-to-text, etc. An image-to-text conversion may use captioning and object recognition algorithms to generate text descriptions of an image. For example, an exemplary image-to-text conversion may include pre-processing, feature extraction, conception, and then caption generation. Pre-processing performs e.g., resizing, normalization, and enhancing the image to improve its quality, and/or any other preparatory modifications for feature extraction. Feature extraction may use a convolutional neural network (CNNs) to extract high-level features that represent objects, shapes, textures, and spatial relationships within the image. The extracted features may then be provided to a language model to generate the caption; common language models include a Recurrent Neural Network (RNN), its variants like Long Short-Term Memory (LSTM), and/or Gated Recurrent Unit (GRU). Post-processing may be used to fit the resulting caption to an appropriate size and descriptiveness. Analogous techniques for speech-to-text and/or sound-to-text may be used with equal success.

In multi-modal embodiments, user context may be processed in their distinct modalities. For example, an LMM may be able to natively combine images, audio, and/or speech within a common framework. Depending on implementation, the LMM may generate an output sequence in natural human language; other implementations may use computer-parsed formats e.g., XML, JSON, etc.

As previously discussed, an edge device may have an input specializer(s) that pre-processes the input (e.g., provides suggested prompt augmentations). However, input specialization may occur with less than full contextual knowledge, and also may introduce irrelevant and/or redundant information. Thus, exemplary embodiments of the aggregator may refine and/or adjust the pre-processed input (user prompt) to construct contextually complete, consistent, and concise queries. This process is referred to throughout as “query construction.”

As used herein, the term “query” and its linguistic derivatives refers to the message that is sent to the destination resource. In some embodiments, the query could be provided in terms of text and/or words (e.g., the user's prompt along with any pre-prompt, mid-prompt, post-prompt, and/or modifiers, etc.). In such implementations, the destination would tokenize the query. However, in other embodiments, the query may be transmitted in the form of tokens/embedding vectors and/or other data structures natively used within a machine learning foundation model.

While the foregoing discussions are presented in the context of a single query that is constructed from a single user input for ease of illustration, query construction is not necessarily 1:1—any M:N mapping may be substituted with equal success. For example, complex user input may be sub-divided into multiple queries. Similarly, simple user input may be aggregated and/or combined with other user input. Here, the simplicity and/or complexity of the user input may be determined via length, subject matter, grammatical construction, multi-modality (verbal and image processing, etc.) and/or any other characteristic of the user input.

In one exemplary embodiment, the aggregator may receive a first set of capture-based prompt augmentations from a first LLM input specializer on a smart glasses and a second set of persona-based prompt augmentations from a second LLM input specializer on the smart phone. In this case, the first LLM input specializer may access a first layer of image-to-text that is reduced in size and/or complexity to operate within the design constraints of the smart glasses. The second LLM input specializer running on the smart phone has access to the user's persona data and may have more generous design constraints (more powerful processor, larger memory, higher thermal dissipation, etc.). Additionally, a second more capable layer of image-to-text may be run on e.g., the smart glasses (or smart phone) when requested, to provide more detailed labeling of the image.

In some cases, the aggregator may additionally determine that more information is needed, and iteratively refine prompt augmentation. Consider a user holding a bottle of soda pop; the first layer of image-to-text may identify the object as “soda”. Initially, this text label may be provided to the smart phone with the prompt augmentations from the capture-based prompt augmentations. While “soda” might be sufficient for a generic query, in this case, the user's persona may include preferred and/or non-preferred types of soda. For example, the persona-based LLM input specializer would have different associations if the “soda” is “Diet Cola” (preferred) versus “Root Beer” (non-preferred). Here, the persona-based LLM input specializer may instruct the second layer of image-to-text to disambiguate the bottle of soda. In one variant, the second layer of image-to-text is executed on the smart glasses, and the updated labels are provided to the smart phone. In other variants, the smart glasses provide the captured region-of-interest image data to the smart phone, and the second layer of image-to-text is executed from the smart phone. In still other variants, the smart phone may forward the region-of-interest to an external 3^{rd} party server for further analysis.

Multiple iterations may be used to refine information to virtually any arbitrary degree. For example, a “musical instrument” might be disambiguated into “guitar” in a first iteration. In a second iteration, the “guitar” might be classified as a “electric” or “acoustic”. In a third iteration, the acoustic guitar might be classified as a “6-string” or a “12-string”. In a fourth iteration, a picture of the 12-string acoustic guitar might be classified into brand and/or model information (e.g., Martin D12-28, etc.). Iterative refinement in this manner allows for sequentially more constrained classification tasks which can be performed only to the extent needed (rather than one monolithic classification task performed to completion).

In some cases, cached information may be retrieved and/or new information may be captured across multiple iterations (e.g., additional image captures and/or request clarifying input from the user, etc.). For example, the smart glasses might attempt to perform image-to-text but determine that a new capture is needed (better lighting conditions, etc.). As a related example, an LLM input specializer may determine that additional information is needed from the user; the user may be asked to clarify the prompt.

In some embodiments, different sensor captures may be iteratively launched for varying degrees of detail. Consider one implementation where a low-power “always-on” camera may be used in combination with a high-resolution camera to provide different types of data. Here, the always-on camera may monitor the external environment at very low resolution, very low frame rates, monochrome, etc. to reduce power consumption. The always-on camera may be used in this configuration to assist with auto exposure (AE) for the high-resolution camera; thus, allowing for much faster high-resolution captures. During operation, a set of eye-tracking cameras may monitor the user's eye motions for gaze point (to determine user intent). When user intent is identified, the high-resolution camera capture is read out in the region-of-interest (ROI) for the user intent (e.g., reducing the field-of-view for power consumption reasons). In this case however, the low-power always-on camera already has image information in a higher field-of-view; this may be acceptable to get a better context of what is happening without providing a larger higher-resolution ROI. For example, a user may be looking at a table, in their living room (discernable from the always-on camera). The high-resolution ROI may be able to identify the object of interest e.g., key, book, etc. and in some cases may even be able to focus on fine details (text, OCR, etc.). Similar concepts may be extended to other types of media (e.g., high-sample rate snippets of a larger sound recording, etc.).

While the foregoing discussions are presented in the context of image-to-text and speech-to-text, virtually any classification and/or recognition logic may be used in combination with the foregoing. For example, some implementations may use e.g., optical character recognition (OCR) and/or reverse brand image search, etc.

In some cases, the aggregator device may have local resources to e.g., respond to the user prompt and/or augmented query. However, the aggregator device may also have access to the broader Internet. In many cases, the aggregator device may enable multi-modal attention for interactions between the user and other network entities. External processing may be used to provide functionalities and/or features beyond the capabilities of the aggregator itself (discussed in greater detail below).

Referring back to FIG. 18, the aggregator device may respond based on its local processing or external processing of the multi-modal attention (step 1858). In some embodiments, the response may be provided at the aggregator device (e.g., smart phone). In other embodiments, the response may be provided to an edge device (e.g., smart glasses) for presentation to the user. In some cases, the response may use the multi-modal attention to generate textual responses via an LLM. Still other implementations may provide the responses in the form of visual information (e.g., image recall), text-based messaging (e.g., text-based virtual assistant), audio playback (e.g., voice-based virtual assistant), webpages or other accessible network resources, and/or any other presentation mode.

### 4.3 Resource Selection and Group Attention

Functionally, the cloud services are used to allocate network resources (e.g., external network entities) for processing requests by, or on behalf of, the user. For example, some (but not all) user queries may be handled with an LLM; other queries may be more efficiently handled with information gleaned from webpages and/or user databases, etc. For reasons explained in greater detail below, appropriate resource allocation improves resource utilization (e.g., computational efficiency, memory footprint, network utilization, etc.). Notably, resource selection is distinct from the other benefits of cloud operation (e.g., offloading processing, memory, and/or power consumption onto other cloud compute resources).

Separately, cloud services may also be used to collect and process attention information from multiple individuals. So-called “group attention” may be particularly useful for social applications. For example, a group of individuals that is coordinating their activities may combine their individual contextual information (instantaneous user context, accumulated user context, user profiles, etc.) to generate group attention. Group attention may then be used to respond to user queries for the group as a whole. For example, a user dining with a group of friends could interact with an LLM that takes the dining preferences of the entire group into account.

As an important corollary, group attention is dynamically derived from a population of users. Unlike conventional schemes which place individuals into fixed groupings/categories (e.g., ethnicity, gender, interests, etc.), the exemplary group attention may be dynamically generated from any arbitrary collection of individuals-without exposing sensitive information about its individual members. This creates opportunities for unique uses; for example, group attention may be used by e.g., a restaurant to identify menu items that drew the attention of its patrons, and perhaps more importantly, its non-patrons (passerby's that could not find any palatable options).

### 4.3.1 Implementation and Design Considerations

Cloud services refer to software services that can be provided from remote data centers. Typically, datacenters include resources, a routing infrastructure, and network interfaces. The datacenter's resource subsystem may include its servers, storage, and scheduling/load balancing logic. The routing subsystem may be composed of switches and/or routers. The network interface may be a gateway that is in communication with the broader internet. The cloud service provides an application programming interface (API) that “virtualizes” the data center's resources into discrete units of server time, memory, space, etc. During operation, a client request services that cause the cloud service to instantiate e.g., an amount of compute time on a server within a memory footprint, which is used to handle the requested service.

Referring first to the resource management subsystem, the data center has a number of physical resources (e.g., servers, storage, etc.) that can be allocated to handle service requests. Here, a server refers to a computer system or software application that provides services, resources, or data to other computers, known as clients, over a network. In most modern cloud compute implementations, servers are distinct from storage—e.g., storage refers to a memory footprint that can be allocated to a service.

Within the context of the present disclosure, data center resources may refer to the type and/or number of processing cycles of a server, memory footprint of a disk, data of a network connection, etc. For example, a server may be defined with great specificity e.g., instruction set, processor speed, cores, cache size, pipeline length, etc. Alternatively, servers may be generalized to very gross parameters (e.g., a number of processing cycles, etc.). Similarly, storage may be requested at varying levels of specificity and/or generality (e.g., size, properties, performance (latency, throughput, error rates, etc.)). In some cases, bulk storage may be treated differently than on-chip cache (e.g., L1, L2, L3, etc.).

Referring now to the routing subsystem, this subsystem connects servers to clients and/or other servers via an interconnected network of switches, routers, gateways, etc. A switch is a network device that connects devices within a single network, such as a LAN. It uses medium access control (MAC) addresses to forward data only to the intended recipient device within the network (Layer 2). A router is a network device that connects multiple networks together and directs data packets between them. Routers typically operate at the network layer (Layer 3).

Lastly, the network interface may specify and/or configure the gateway operation. A gateway is a network device that acts as a bridge between different networks, enabling communication and data transfer between them. Gateways are particularly important when the networks use different protocols or architectures. While routers direct traffic within and between networks, gateways translate between different network protocols or architectures-a router that provides protocol translation or other services beyond simple routing may also be considered a gateway.

Generally, these physical resources are accessible under a variety of different configurations that are suited for different types of applications. For example, a data center might offer: infrastructure as a service (IaaS), platform as a service (PaaS), and software as a service (SaaS). These classes of service provide to different levels of control/abstraction of the underlying resources. For example, IaaS might provide the most flexibility and control for cloud services, but this may require the cloud service account for and manage the underlying information technology infrastructure. In contrast, SaaS is most efficient where the client service imposes few (if any) requirements on the underlying hardware. IaaS and SaaS are at two ends of a spectrum, PaaS may provide some of the flexibility of IaaS, with some of the convenience of SaaS. As but one such example, a cloud service request for an IaaS might specify the underlying compute resource by processor, memory footprint, operating system, network setup (IP configuration), and/or application software. In contrast, a SaaS cloud service might only specify the source code for the application, etc.

Conceptually, cloud services access, reserve, and use physically remote computing resources (e.g., processing cycles, memory, data, applications, etc.) with different degrees of physical hardware and/or infrastructure management. Modern data centers handle many different cloud services from a myriad of different entities—it's not uncommon for data centers to have average utilizations north of 60% (which compares favorably to the average utilization (<1%) for dedicated servers infrastructures). Computational efficiencies are directly passed onto the cloud service as operational cost; in other words, cloud services are only charged for the resources that they request.

Cloud services are often leveraged to reduce the resource burden for embedded devices-processing intensive and/or best effort tasks can be handled in the cloud. However, efficient usage of cloud services often requires different design considerations from embedded devices. For example, cloud services benefit from careful resource allocation; over-allocation, under-allocation, and/or any other type of mis-allocation can be very inefficient (too much idle time, excessive resource churn, etc.). This is particularly problematic when scaled over multiple instances. In contrast, embedded devices are physically constrained and cannot be virtually scaled. Thus, embedded devices are often conservatively designed to match its e.g., most likely use cases, worst case use cases, etc. Embedded devices offer significant performance enhancements and/or security relative to cloud-based counterparts. For comparison, once configured, inter-data center communication is lox slower than intra-data center communication, which is lox slower than on-device communication.

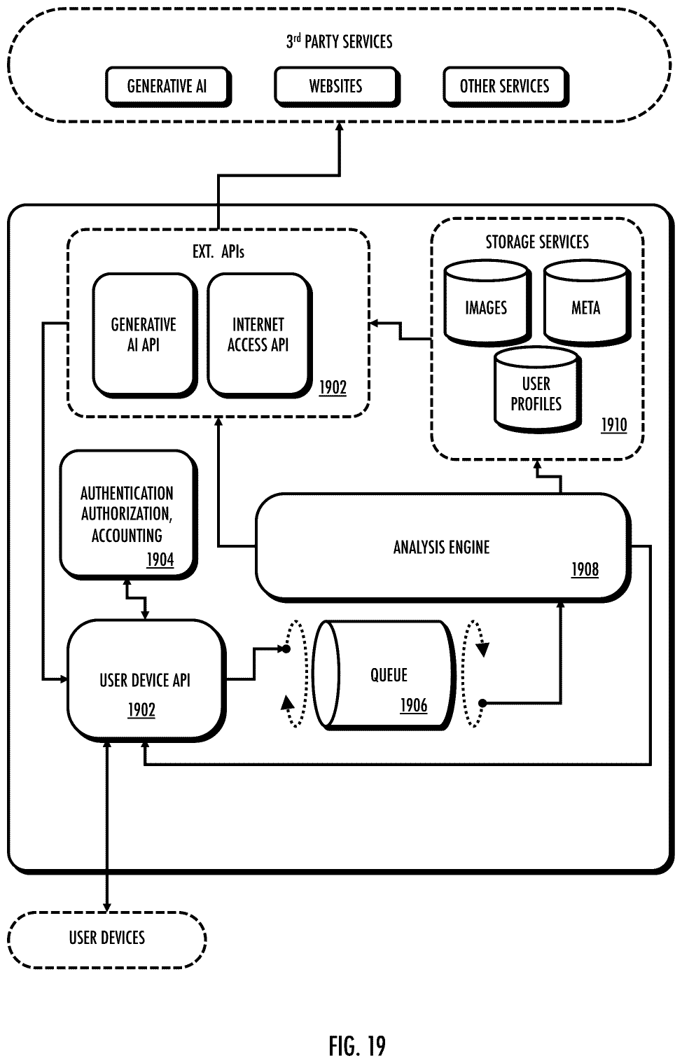

Due to the virtualized nature of cloud services, logical entities are often described in terms of their constituent services, rather than their physical implementation. FIG. 19 is a logical block diagram of one exemplary intermediary cloud service 1900. The cloud service includes: one or more application programming interfaces (APIs) 1902, an Authentication, Authorization, and Accounting (AAA) server 1904, a scheduling queue 1906, an analysis engine 1908, and storage 1910. External resources may refer to any foundation models, websites, and/or other services.

An API (Application Programming Interface) is a set of rules and protocols that allows different software applications to communicate and interact with each other. It defines the methods, data formats, and conventions that enable access to, and functionality of, a software service, library, or platform. The illustrated implementation includes both device APIs and external APIs to interact with the other components of the system. The device APIs enable the aggregator device and/or the edge devices to communicate with the intermediary cloud service 1900, the external APIs are used by the intermediary cloud service 1900 to launch processing requests on external network entities. In the illustrated embodiment, the external API may additionally be bifurcated into generative AI APIs, as well as more conventional internet access APIs.

An Authentication, Authorization, and Accounting (AAA) server 1904 is a system that provides authentication, authorization, and accounting services for networked resources and services. The authentication component of an AAA server verifies the identity of users or entities attempting to access a system or resource. It validates the credentials provided by the user, such as usernames, passwords, digital certificates, or other authentication factors, to ensure their authenticity.

The authorization component determines what actions or resources a user or entity is allowed to access based on their authenticated identity and specific permissions. It defines the rules and policies that govern access control and ensures that users only have access to the resources they are authorized to use.

The accounting component of an AAA server tracks and records information about the usage and consumption of network resources. It collects data related to user activities, such as the duration of sessions, data transferred, and services accessed. This data can be used for billing, auditing, network monitoring, or generating reports on resource utilization.

Within the context of the present disclosure, the AAA server manages access control to cloud resources for both the users as well as the external network resources. For example, a user may need to authenticate their identity in order to access their data. Once authenticated, authorizations and accounting are checked to ensure that the user can e.g., perform a requested action, add new data, remove data, etc. Similarly, other users and/or external network resources may need to comply with authentication and/or authorization protocols. For example, a first user may want to access the user context of a second user for group attention-based applications. Similarly, an LLM or other network entity may request supplemental user context. Depending on the user's configured access control, these requests may be granted or denied (in whole or part). In some cases, default rules may be used for convenience. Some such variants may additionally provide user notifications and/or manual override options.

A scheduling queue 1906 manages and organizes tasks or processes that are waiting to be executed. The scheduling queue determines the order in which tasks are processed, ensuring efficient utilization of resources and adherence to specific policies or priorities. Typically, a scheduling queue uses a First-In-First-Out (FIFO). The FIFO may store a collection of tasks; the addition of new tasks takes place at one end, known as the “rear” or “tail,” and the removal of elements occurs from the other end, called the “front” or “head.” More generally, any data structure suitable for job scheduling, task management, event handling, and resource allocation, may be substituted with equal success. As but one such example, round robin queues may be used to ensure that tasks are scheduled equally (or according to some fairness metric). Priority queues and Multi-level queues may be used to schedule tasks according different prioritizations and/or categorizations. Shortest Job Next (SJN) (also referred to as Shortest Job First (SJF)) and Shortest Remaining Time (SRT) queuing are often used to reduce the average wait time. Earliest Deadline First (EDF) is commonly used in time constrained applications (e.g., real-time scheduling).

A storage 1910 is configured to structure and collect data in a manner that allows efficient storage, retrieval, and manipulation of information. Here, the illustrated implementation includes user context (instantaneous user context, accumulated user context, and/or user interest), user-specific images, user-specific metadata, and user profiles.

The storage 1910 organizes user-specific data according to any number of relational schemas. Common examples of such schemas may associate data according to user, modality, time, location, metadata (extracted features, etc.). Queries may be made against the database, according to authorizations and/or other access control restrictions. For example, a user may query the database for their own data at a first level of access (unrestricted) but may have a reduced second level of access to other user's data. Other databases may be substituted with equal success.

In some embodiments, the storage 1910 may be accessible via externalized APIs 1902. This may enable RAG-like libraries of user-specific data (discussed elsewhere). For example, the externalized APIs 1902 may allow an external network resource to access user-specific data, according to an authorization level. In some cases, this may be extended to multiple user access (e.g., a RAG-like library for a group of users, discussed elsewhere).

An analysis engine 1908 performs analysis on metadata or input (e.g., user context and/or user interactions) to extract meaningful insights, patterns, or conclusions. The analysis engine may be configured to perform: data ingestion, pre-processing, processing, and post-processing.

During data ingestion, the analysis engine receives data or input from various sources, such as databases, files, aggregator devices and/or edge devices. If pre-processing is necessary, then the analysis engine routes data to the appropriate network component for handling and/or parses data into its relevant components. For example, edge context may be archived and/or used to update cloud context. In other examples, user input may be pre-formatted for use with e.g., an LLM-based chatbot. Some variants may additionally identify and retrieve related contextual data for initialization data.

In some variants, the analysis engine 1908 may also perform processing of the task itself. For example, some implementations may incorporate a local LLM-based chatbot. Other tasks that can be readily performed may include data retrieval, data storage, and/or other data management of the storage 1910. Some tasks may offload processing to external 3^{rd} parties via API interfaces.

Once processing has completed, results may be presented to the user. While the disclosed embodiments describe a messaging type interface, other interfaces may be substituted with equal success. Presentation may be handled at the aggregator and/or edge devices (discussed elsewhere).

Referring back to the APIs 1902 of FIG. 19, conventional internet access APIs may be based on a server endpoint that supports one or more client endpoints. Generally, the server endpoint has a URL (which translates to an IP address) to send and receive requests and responses. Clients send and receive using HTTP methods e.g., GET, POST, PUT, DELETE. The responses are usually provided in computer-parsed formats (e.g., JSON, XML, etc.). The server and client endpoints may additionally support authentication and authorization, rate limiting, and error handling protocols. Artisans of ordinary skill in the related arts will readily appreciate that the server and client may coordinate via complementary function calls to implement very sophisticated logical interactions over the underlying API framework.

LLMs (and other generative intelligence) typically use conventional APIs to accept input text (user queries, prompts, and text passages) and provide output text (e.g., the transformed output). More recently, so-called Retrieval-Augmented Generation (RAG) LLMs have combined retrieval-based APIs with LLM functionality. A RAG-based LLM allows a client to provide a query along with a relevant library (e.g., documents or pieces of information from a predefined dataset or knowledge base). The RAG-based LLM uses the library to generate a response. In particular, a RAG-based LLM may obtain the entire library, filter/rank the library contents based on the query, and then combine the filtered documents to the LLM as contextual information to answer the query. Existing RAG-based LLMs are primarily directed to avoiding hallucinations. In other words, RAG-based LLMs are focused on providing the LLM with access to databases of pre-verified information, such that the resulting LLM output is truthful and contextually appropriate.

Various embodiments of the present disclosure combine RAG-like libraries of user-specific data to LLMs. In particular, instead of identifying publicly accessible network resources for retrieval augmented generation, the exemplary API provides user-specific media, metadata, and user context for the LLM as context to answer from. Providing user-specific information to an external LLM introduces multiple challenges. First, security and privacy are needed to safeguard sensitive user information. Second, only a portion of the user-specific information may be relevant-to and/or authorized-for the query—reducing the amount of extraneous information reduces downstream processing. Thirdly, LLMs are capable of transforming existing data structures into new data structures having different characteristics—this may be used to generate information from the individual user domain into a group user domain and vice versa.

The following discussions explore these aspects of the exemplary user-specific generative intelligence system in greater detail.

### 4.3.2 Resource Selection and Session Management

In some embodiments, the aggregator and/or edge devices may provide user context and/or attention to the cloud service for processing. For example, the aggregator may provide multi-modal user context and its corresponding aggregated attention for a “virtual assistant” application. In other embodiments, the aggregator and/or edge devices may directly perform resource selection and use the cloud service as a helpful intermediary (e.g., for session management, additional resources, etc.). More generally, the following discussion is presented in the context of resource selection and session management at the intermediary cloud services based on e.g., available resources, security, privacy, and/or any number of other differentiating characteristics, however the concepts may be broadly applicable to resource selection/session management by any logical entity.

As a brief aside, LLMs widely vary in capabilities and function. While it is true that larger (and more expensive) models generally outperform smaller (less expensive models), there are many other important considerations. Some LLMs may have access to topical knowledge (e.g., LLMs that have been trained for specific topics or tasks)—these LLMs do far better in their narrowed field (e.g., medical, scientific, etc.), but are not suitable for general use. Other LLMs may have fast response times, larger token limits, handle complicated grammatical structures, etc. In some cases, an LLM may not even be the ideal source of information e.g., a user may just want the direct internet resource or local search result. In other words, selecting the correct LM or other resource may be a critical decision. For example, a research scientist user may use a topically-specific LLM to assist in answering quick questions, yet that same user might “change hats” and need to do grocery shopping after work, a task better suited for a different general-purpose LLM. A work-related prompt does not need ancillary information about the user's dietary preferences, and vice versa.

In one specific implementation, resource selection uses LLM-like logical components to perform destination selection. For example, much like an LLM, a query constructor may include an encoder that accepts text or token-based input. The results are fed to a decoder; however, the decoder is not trained to provide text output; instead, the decoder provides softmax values for different destination resources. In other words, rather than trying to predict the next word in the sentence, the query constructor attempts to predict the resource that is able to answer the query. Since most implementations will only select between a few candidate destinations (rather than a full lexicon of spoken language), destination selection can be performed on e.g., a smart phone or intermediary cloud service with minimal multi-head attention model and soft max selection logic.

A softmax score above a cut-off threshold indicates that a resource is suitable. A so-called “indeterminate” selection occurs where no destination exceeds the minimum cut-off threshold. In other words, more information may be needed in order to identify a suitable resource. In some cases, indeterminate values may trigger iterative prompt refinement (discussed above)—the user may be asked to clarify their request, additional information may be retrieved from the user device, etc. In some implementations, a default destination resource may be used for indeterminate values; this may be useful where a user may want to send a request for a fast response (e.g., relying on the downstream LLM to resolve the ambiguities).

A so-called “ambivalent” selection occurs where multiple destinations exceed the minimum cut-off threshold. In some variants, the highest scoring resource is selected as the destination resource. In other variants, multiple requests may be sequentially or simultaneously launched (as discussed in greater detail below) for any of the suitable resources. In still other variants, the results may be iteratively refined until a single resource is identified.

While the foregoing discussion describes an LLM-like logic that can process words/tokens to identify the destination resource, virtually any scoring and/or decision logic configured to select a destination resource based on a user generated prompt, machine generated prompt augmentations, and/or accumulated personalization data may be substituted with equal success. In some embodiments, the scoring and/or decision logic determines the relative complexity of the desired query (e.g., whether a search is easy or hard, etc.); the query may be modified to fit the destination, or the destination may be changed based on the query complexity. As another such example, the scoring and/or decision logic may consider whether the information is user-specific (or local) or generalized. User specific queries (e.g., “Where are my keys”) may be transmitted to a user-specific database for processing whereas generalized queries may be directed to other internet resources. Still other implementations may use topical information to determine whether the query should go to a topically-specific LLM or a general-purpose LLM. Here, topically-specific queries may be recognized through the usage of topically-relevant tokens; in other words, some LLMs recognize unique tokens (and/or combinations of tokens) that other LLMs do not.

While the foregoing discussion is presented in the context of text-based queries, the concepts may be broadly applied to large multi-modal models. For example, such implementations may use components akin to a large multi-modal model (LMM). In such implementations, the LMM-like resource selection logic may directly access region-of-interest (ROI) data and/or comprehensive image data; this may be important where the destination network resources are tasked to operate on image data. Similarly, other implementations may allow the LMM-like resource selection logic to directly access recorded audio waveforms, location and/or IMU data, etc.

As previously alluded to, resource selection may be based on a large number of potential prompt augmentations based on e.g., captured images, user instructions, and persona data-however, these suggestions may have been based on partial information and/or may have been made without knowledge of the destination resource. While iterative refinement may be used to obtain more information, the LLM-like resource selector logic (e.g., query constructor and/or intermediary cloud service) may also need to prune away redundant/unnecessary information. In other words, once the destination resource(s) are selected, the unnecessary portions of the query which do not appear to affect the desired response may be pruned away to reduce downstream processing. Prompt augmentations that appear to significantly overlap other prompt augmentations may be removed in whole, or combined together, to remove redundant portions. For example, a capture-based pre-prompt might be: “I am holding spinach” and a personality-based pre-prompt might be: “I am vegetarian”—while the vegetarian information might be useful in some contexts, within this specific context it may be redundant and can be removed.

As a related consideration, the positional encoding varies across LLM implementations. In other words, different LLMs may weight the information of various portions of a query differently. Thus, the LLM-like resource selector logic may modify prompt augmentation in view of the positional encoding of the destination LLM. For example, consider a destination LLM that prioritizes information at the start and end of a query over information in the middle. While the LLM input specializers may conservatively provide multiple options for positionally encoding a specific piece of information (a pre-prompt, mid-prompt, and post-prompt), the LLM-like resource selector logic may only include the option that corresponds to the importance of the information. Here, important information might be placed in a pre-prompt, background information might be provided in the mid-prompt, etc.

In some embodiments, session management logic (e.g., query constructor and/or intermediary cloud service) may separately store the state of the user's conversation. Here, the conversation state is locally stored and distinct from the destination LLM's session state (or context window); in other words, the conversation state may persist over many conversations and/or may have much larger (potentially limitless) token limits. Conversation state can be used to refresh and/or re-initiate a conversation with a destination LLM such that the conversation remains coherent to the user. When the token limit for the destination LLM is exceeded, the session management logic may selectively include or even re-insert prompt augmentations which ensure that the relevant tokens are present.

Furthermore, sometimes the LLM session state may time-out from disuse. Here, the session management logic (e.g., query constructor and/or intermediary cloud service) can resurrect the previous LLM session state by pre-emptively sending pre-prompts to establish critical details that the user is interested in. Consider, for example, a user that asked “What can I cook with this ingredient?” at the grocery store. They bought the ingredient and returned home. In the intervening time, their previous LLM session may have timed out. Here, the session management logic may reconstruct the previous conversation, so that when the user asks, “can I add this spice to the recipe?” the question is answered in the context of the same recipe that they were shown at the grocery store.

Decoupling conversational state from session state allows a LLM to seamlessly pick up a conversation, either from a previous conversation, or in some cases, from another LLM. In one specific implementation, the session management logic may independently track the user's conversational state. In simple implementations, this may be a stored text record of a running dialogue between the user and the glasses; the dialogue may then be used to generate prompt augmentations to bring the LLM up to the current conversational state. Some LLMs may directly expose session state (or context window) information via an API (application programming interface) or similar communication protocol; in such implementations, the session management logic may request session state and/or prime the session state via the API.

While the foregoing discussion is described in the context of a user-initiated process, the concepts may be broadly extended to machine-initiated processes as well. As but one such example, the session management logic may pre-emptively launch LLM queries based on image-to-text (or speech-to-text, IMU, etc.) input that is captured from the smart glasses. This may be useful to keep the session management logic up to date on the user's environment, activities, etc. Consider, for example, a smart phone that is tracking the user's location in the background during their day-to-day activities; when a user appears to be in an important location (e.g., based on persona data, etc.), the session management logic may pre-emptively trigger an image capture of the user's gaze point and send LLM queries to e.g., prime the conversation state with information about the user's environment. These initial LLM queries may be performed before the user has said anything (before speech-to-text) and may even be discarded if not useful. However, priming inquiries may provide a much broader basis of information and, if performed in advance and cached, will not add to response latency. In other words, priming may provide a contextually-aware (nearly prescient) user experience.

As previously alluded to, the session management logic (e.g., aggregator and/or the intermediary cloud service) may decouple the user's conversation state from the external resource's session state. This flexibility allows the session management logic to launch multiple queries to multiple destination resources and select only the most suitable results. For example, a user may have an ongoing conversation that is drawn from the output of multiple LLMs (i.e., where each LLM only contributes to a portion of the conversation).

Conceptually, the LLM's session state (context window) defines the text sequence that is used to generate the response. The LLMs own responses form part of the context window; this is needed so that the LLM remains self-consistent. However, in a multi-session conversation, none of the LLMs have a complete version of the conversation. Instead, the session management logic manages the conversation state and disseminates information to the destination LLMs as needed.

In some embodiments, the queries are constructed (“primed”) so that the LLMs' session state (context window) matches the relevant portion of the conversation state. For example, the relevant portions of the conversation state may be based on recency. In one such implementation, an LLM with a token limit of 4096 might only need the 4096 most recent tokens of the user's conversation state. More complex implementations may consider the user's input and/or surroundings (e.g., relevant subject matter, region-of-interest, gaze point, etc.). For example, the session management logic might filter conversation state based on what the user is talking about and/or looking at. More generally, any information that corresponds to the user's state of mind and/or intent may be used to select the most relevant portions of the conversation state with equal success.

Different LLMs have different token limits, knowledge bases, and/or training and may need different portions of conversation state. For example, a large LLM may receive much more conversational state (e.g., 16K tokens) versus a small LLM or small language model (SLM) (e.g., 4K tokens), etc. Furthermore, different LLMs have different tokenization and/or respond to different types of prompt engineering. In other words, the session management logic may need to separately fashion different queries based on each LLM's capabilities.

In some implementations, resource selection logic and session management logic may coordinate operation. This may be useful where multiple sessions are used to generate responses. Here, the session management logic selects one response from the received responses for presentation to the user. The selection criteria from the session management logic's response selection (e.g., softmax values, confidence values, etc.) may be fed back to the resource selection logic to assist and/or improve in the next resource selection.

Multiple parallel sessions may be used to combine the capabilities of multiple LLMs to optimize for the user's experience rather than the LLMs own considerations. In other words, the user experiences fast responses for simple questions, while also benefitting from in-depth answers where necessary. Selection may be based on a variety of criteria e.g., response time, response length, response quality, etc. As but one such example, multiple queries may be launched to models of different complexity; while a simple model can answer more quickly, the complex model may answer more accurately. Here, the first response that sufficiently answers the query is used. As another such example, multiple queries may be launched to LLMs with access to different libraries of information. The most comprehensive response (that is not a hallucination) may be used.

The session management logic updates its conversation state and presents the selected response. As previously noted, the conversation state is updated based on only the selected response and its corresponding query; the unused responses and queries are discarded. In simple embodiments, conversation state may be stored as a text dialogue. In other implementations, the conversation state may be represented as a set of tokens, embedding vectors, and/or any other representation of the conversation state. Since conversation state is internally managed by the session management logic, the user does not see the other responses.

### 4.3.3 Persona Stitching

In some embodiments, a cloud service may periodically “stitch” user context into a “persona”; the persona may be further used to further refine prompt augmentation, etc. Conceptually, edge devices have access to many different modalities of user context (e.g., smart glasses may capture images and audio, smart phones may capture online interactions and location information), however they are often constrained by their available resources. The cloud service has access to nearly unlimited computational power and memory—this may be particularly important for computationally intensive stitching discussed below.

While the following discussion is presented in the context of a cloud-based “stitcher”, any device with sufficient resources may be substituted with equal success. For example, stitching could be performed via server, personal computer, laptop, etc. Furthermore, artisans of ordinary skill in the related arts will readily appreciate that technology continues to improve such that future technologies may perform stitching in form factors that are currently infeasible (e.g., smart watch, smart glasses, etc.).

As used herein, the term “persona” refers to a body of history-based user-specific information that enables the machine-generated prompt augmentation, LLM-selection, and/or other modifications of the control and/or data path for natural language processing. Persona information is not based on the user's words, gaze, or other sensed environment, but is retrieved from e.g., a user-specific database, cloud archival, etc. In one embodiment, the persona data structure maps user-specific relationships between tokens/embedding vectors of the foundation model. Persona dynamically changes as newly observed data points constructively/destructively reinforce previously identified relationships. New relationships may also be created from observed patterns of behavior.

Persona may be used to vary responses in many different ways. Different people asking the same prompt may receive different results due to differences in their personas. For example, a cinephile that asks for movie recommendations should receive more targeted recommendations for their tastes and also may prefer a richer set of information about the movies in comparison to a casual filmgoer. In some cases, the same user may want to receive different responses for similar queries, based on different contextual environments/times, etc. For instance, a user that asks for restaurant suggestions at work (e.g., convenience, networking opportunities, etc.) may have a different purpose than suggestions at home (e.g., healthy, kid-friendly, etc.). Still further, a person focusing their intent on different items of interest (targets) should receive different responses based on their relationship to those objects. For instance, a user's questions about a brand-new car (versus their owned car) are likely to be quite different.

In one specific embodiment, persona information may be cumulatively updated with user activity. Initially, persona might include basic personal information e.g., name, age, gender, home address, work address, schedule, social connections, and their corresponding details (e.g., family, friends, co-workers, etc.); this may be provided directly by the user via an intake questionnaire and/or scraped from existing data, calendars, and/or social media, etc. In one such embodiment, a virtual assistant software can ask questions to learn about a user's preferences based on certain triggering events. For example, after visiting a restaurant, the virtual assistant may ask: “How did this meal compare to the last one at Restaurant A?” and/or “What rating would you give this meal?”, etc.

Over time, the user's edge devices accumulate a broad spectrum of data during day-to-day activities (e.g., images captured over time, region-of-interest and gaze mapping information, vocal prompts, etc.). In addition to smart glasses data, the smart phone may also record daily travel, patterns of use, current interests, social networking activity, communications, etc. The physical and virtual activity of the user is then “stitched” into the persona information. In some cases, persona information may also be manually added to, removed from, and/or otherwise edited by the user (if desired) so as to further improve user experience.

As used herein, the term “stitching” (or “dreaming”) and their linguistic derivatives refers to the process of creating new relationships (and/or fitting existing relationships) to newly observed data within the high dimensional space of a foundation model framework. This enables high dimensional connections within the foundation model framework beyond the newly observed data points. For example, consider a person that regularly commutes between 8 AM-9 AM and 5 PM-6 PM; these time ranges may be labeled as “commute”. Labeling in the natural language format inherits the full descriptive richness of the tokens/embedding vectors of the foundation model; e.g., the tokens/embedding vectors for “commute” are additionally related to “work”, “keys”, “car”, etc. in high dimensional space. Thus, for example, “where did I use my keys last?” could result in the response “you used your keys for your commute.”

In one specific variant, accumulated data from the smart glasses and/or smart phone is periodically stitched to identify temporal, spatial, and/or activity patterns of the user across the day. When compared across days, the stitching may establish patterns of a user's daily routine. The daily patterns and/or routines may be described in text and converted to tokens. Importantly, certain salient user interactions (e.g., gaze point information and/or user generated prompts) and/or machine responses are already converted to tokens as a part of the LLM query-response interaction—these transactions may be stitched “as-is” from cached history data.

As but one such example, the stitching process may include pattern recognition over the previously used tokens/embedding vectors accumulated throughout the user's day-to-day activities. For example, image-to-text may be used to convert images into labels; these labels are then converted to tokens/embedding vector, etc. Similarly, labels and tokens/embedding vectors from vocal instructions and other forms of activity data (e.g., calendar data, physical location history, browsing history, health, and activity monitoring data, etc.) may be collected. These label data and tokens/embedding vectors are then correlated between each other to identify repetitive user patterns based on time, location, activity, etc. The resulting candidate matches are used to reinforce the existing associations (if any) in the user's persona, or to create new associations.

For example, consider a user that likes to hear news articles during their commute. Initially, they ask for news articles during their commute, and repeat this pattern over a few days. This pattern is captured as a user-specific routine. Later, during offline stitching, the “commute” label for this user may be associated with the user's news article preferences, etc. As a result, future queries may detect that the user is about to start their commute, and pre-emptively download suitable news articles. Importantly, this connection (which likely did not exist before) is inferred from user-specific patterns in high dimensional space—e.g., “commute” and “news” are typically not linguistically related. Different user's might use their commute time differently e.g., to check email, plan their to-do list, shop for clothes, play games, etc. In other words, this is a personalization learned through observed user activities (not searched for among sets of archetypes).

As another such example, a user may have a regular morning routine. The user might e.g., wake up, have a light meal, do some calisthenics, get dressed, meditate, and leave for work. This pattern is captured as another user-specific routine. Later, during offline stitching, the labels for these activities are stitched together. Once in a while, the user may be interrupted during their routine—the user may then ask, or be proactively prompted, to resume their normal routine. Again, it is important to emphasize that this personalization is stitched together over time from observations of the user's activity.

There are conventional technologies that already mine user data for data connections, however many of these techniques are focused on fitting the user according to a predefined set of criteria or a predefined tranche of similar users (e.g., mining user data to provide advertising relevancy, etc.). While this provides the most straightforward and efficient mapping of a user against known archetypes (such as marketing demographics), it is intractable for arbitrary connections between all possible words. In other words, these techniques require searching against a known search space; larger search spaces result in exponentially growing complexity.

In contrast, the exemplary techniques grow user-specific associations from observed data points, according to the embedding vectors of the high dimensional space. Connections are observed as they occur and stitched as a background process; this does not require a “search” process. This technique for stitching new relationships into an existing high dimensional space is much more tractable for consumer electronics.

In one specific implementation, the strength of association may be based on repetition. For example, associations may be recently adopted, short term, long term, habitual, etc. Habitual associations may be the most strongly weighted. In some cases, the user may have the ability to reset some or all of their identified associations. This may be particularly useful where a change drastically affects previously established behavior. For example, moving to a new home might change a previously habitual commute pattern; a hard reset allows the user to re-establish a new commute pattern without being bothered by irrelevant old commute patterns. More generally, however, strength of association may be based on a variety of factors e.g., emotional state, social reinforcement, user preference, device considerations, etc.

While the present disclosure is discussed in the context of a single persona for a user, the various techniques could be broadly extended to multiple personas for a single person. For example, a person might want to separate their work persona from their home persona, etc. Such a division may be useful to explicitly silo certain types of user activities and/or preferences, etc. Furthermore, while the following discussion is presented in the context of a single user, the concepts may be broadly applied to groups of users. For example, friends at a restaurant ordering multiple dishes to share might create a group persona that reflects the aggregated preferences of the friends as a whole.

### 4.3.4 Group Attention for Social Applications

In some embodiments, the analysis engine may be used to assess user requests within the context of social applications. Here, the analysis engine may include a non-transitory computer-readable medium that includes a routine that causes the cloud service to: obtain a user request and multiple user context, encode and/or decode the user request and multiple user context to assess group attention, and access network resources based on the group attention.

As a brief aside, attention in LLM-based chatbots are typically derived from sentences of a single user. However, the mixed modality inputs described above may be more broadly extended to multiple users. By combining user context from multiple users, a transformer can synthesize “group attention”. Since the focus is on the overall patterns and trends within the group data rather than on specific individuals, group attention aggregates data from multiple users unidirectionally—the individual user's context data cannot be reversed back out. More directly, depending on the group size and diversity, this may impart a loose form of anonymity. In other words, group attention may focus attention insights from the collective behavior of the group, while maintaining the privacy and anonymity of each user's input.

First, the cloud service may obtain a set of users. Consider a scenario where multiple users are trying to pick a restaurant to eat at. Each of the users may have their own likes and/or dislikes, however it may be inconvenient and/or infeasible to enumerate everyone's preferences. Here, a temporary “group” may be created that identifies the users as “members” of the group and their relevant access control.

Different members of the group may independently control the group's access to their information. Some members may want the group selections incorporated with their individual preferences, whereas others may only want their preferences reflected in the group selection but discarded after use. The users may have default settings for collaboration and/or sharing. Users may also have notification settings to alert them when their information is being used for a group, application, and/or other contextual information.

The group itself may also independently control access to its data. For example, a group administrator may identify members that have increased privileges (e.g., an administrator may have the ability to add, remove, and/or modify members, etc.). Certain members of the group may have prioritization over others (e.g., a celebration may want to ensure that one guest's preferences are prioritized over others, etc.).

Alternatively, the group may obtain information from its members. For example, the group may retrieve persona information to generate a group persona. In other cases, the users may push their information to the group. Push based embodiments may be particularly useful where the users may want to individually control what is provided to the group.

Once the cloud service has obtained the relevant member personas, the cloud service generates a group persona that reflects the member's aggregated characteristics. In some cases, the group persona may reconcile differences between the members (e.g., price point preferences), in other cases the group persona may preserve distinct characteristics (e.g., vegan, vegetarian, pescetarian, etc.). This information may be used to e.g., seed an LLM-based chatbot for a virtual assistant.

Once the cloud service has both group persona and group context, the cloud service encodes and/or decodes the group context to assess group attention. In one embodiment, much like aggregation of single user context, group attention may use an LLM, LMM, or similar foundation model to process the member context. Within the context of the present disclosure, the cloud service combines data from multiple members into an input sequence that can be processed within a transformer model. In one specific implementation, the input sequence is based on information gathered across different members.

In one embodiment, member context is converted into a common modality. Alternatively, multi-modal embodiments may process member context in their distinct modalities. Similarly, the aforementioned concepts of input specialization and query construction may be readily adapted. For example, each member may provide some pre-canned information using an input specializer (e.g., this member is a vegetarian), whereas the group-based query constructor may reduce and/or remove redundant information (e.g., all members are vegetarian).

In some cases, the cloud service may additionally determine that more information is needed and launch conversations to individual members to iteratively refine the results. For example, the cloud service may provide a list of options, and ask each user to rate their most preferred options, etc. Multiple iterations may be used to refine information to virtually any arbitrary degree. Iterative refinement may also enable sequentially constrained classification tasks which can be performed only to the extent needed (rather than one monolithic classification task performed to completion).

In some cases, the cloud service may perform analysis using its analysis engine. In other cases, the cloud service may externalize this functionality to another network resource. Here, the cloud service may provide access to its stored user-specific information for RAG-like interactions.

While the foregoing examples are presented in the context of an explicitly defined membership (e.g., a group that is joined by users and/or that is created by an administrator), these concepts may be further extended to applications where the membership is implicitly defined, or even nascent (yet-to-be-defined). For example, most user-facing social applications enable users to associate with one another (e.g., meetup, dating, etc.). However, anecdotal evidence suggests that privacy concerns and categorization filtering results often hide underlying patterns in these same social networking mechanisms.

As previously noted, group attention (and/or group features) may be mined wholly separate (and anonymously) from the underlying user-specific data. In other words, group attention is a unidirectionally derived form of data which cannot be traced back to its constituent data. Furthermore, passively gathered user context (i.e., user context which is not a product of user expression) lacks subjective meaning and can be used objectively for e.g., feature extraction, transformations, etc.

Consider, for example, a crop blight scenario that is independently observed by many different farmers. Conventional solutions would limit communication between farmers to their social circles and/or attempt to group the farmer based on known categories (e.g., other farmers having the same crops, neighboring farmers planting different crops, etc.). Yet conventional mechanisms might not have access to farmers that had independently observed the same symptoms but failed to report it. Similarly, farmers may have misreported similar blight resulting in misclassification. In contrast, the passive observations by edge devices of many farmers, may, when combined result in an implicit group attention of farmers to crop blight. This may be monitored by an agency to anticipate crop blight.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for managing hierarchical user context, comprising:
causing one or more edge devices to capture a plurality of instantaneous user context, where the one or more edge devices additionally detect user interest in a first subset of the plurality of instantaneous user context;
decoding attention based on the first subset at an aggregator device;
encoding an accumulated user context based on the attention; and
storing the accumulated user context at a cloud service.

2. The method of claim 1, further comprising configuring the one or more edge devices to capture the plurality of instantaneous user context according to a time interval.

3. The method of claim 1, further comprising configuring the one or more edge devices to capture the plurality of instantaneous user context based on trigger events.

4. The method of claim 1, further comprising configuring the one or more edge devices to detect the user interest based on a user interaction.

5. The method of claim 1, further comprising decoding the attention from captions generated by computer-vision analysis of the plurality of instantaneous user context,
where the captions are smaller than the plurality of instantaneous user context.

6. The method of claim 5, where the attention is decoded from the captions based on a large language model.

7. The method of claim 6, where the accumulated user context is encoded based on the large language model.

8. The method of claim 7, where the accumulated user context is smaller than the captions.

9. The method of claim 1, where the plurality of instantaneous user context comprises an always-on image captured at a first field-of-view and a region-of-interest image captured at a second field-of-view.

10. The method of claim 9, where an object is detected based on the always-on image.

11. The method of claim 9, where the user interest is detected based on the region-of-interest image.

12. An apparatus, comprising:
a processor; and
a non-transitory computer-readable medium comprising instructions that when executed by the processor, cause the processor to:
obtain a user prompt;
obtain instantaneous user context from at least one edge device;
retrieve accumulated user context from a cloud service; and
decode attention based on the user prompt, the instantaneous user context, and the accumulated user context.

13. The apparatus of claim 12, where the user prompt, the instantaneous user context, and the accumulated user context comprise at least two modalities of data.

14. The apparatus of claim 13, where the user prompt is text or speech.

15. The apparatus of claim 13, where the instantaneous user context is image, sound, or location.

16. The apparatus of claim 13, where the accumulated user context is text or tokens.

17. The apparatus of claim 12, where the instructions further cause the processor to generate a query for a large language model based on the attention.

18. An apparatus, comprising:
a processor; and
a non-transitory computer-readable medium comprising instructions that when executed by the processor, cause the processor to:
obtain a request from a large language model;
obtain instantaneous user context from at least one edge device or retrieve accumulated user context from a cloud service based on the request; and
generate a response to the request based on the instantaneous user context or the accumulated user context.

19. The apparatus of claim 18, where the request, the instantaneous user context, and the accumulated user context comprise at least two modalities of data.

20. The apparatus of claim 18, where the instructions further cause the processor to cause the at least one edge device to capture the instantaneous user context.

21. The apparatus of claim 20, where the instantaneous user context comprises image data and the instructions further cause the processor to generate text captions based on the image data.

22. The apparatus of claim 20, where the instantaneous user context comprises location data and the instructions further cause the processor to generate text captions based on the location data.

23. The apparatus of claim 18, where the accumulated user context comprises text captions generated based on previously captured image data or location data.
